(19) United States
(12) Patent Application Publication
(10) Pub. No.: US 2022/0071201 A1
(43) Pub. Date: Mar. 10, 2022

(54) PERACETIC ACID STABILIZED COMPOSITIONS WITH POLYMERIC RESINS CHELATORS

(71) Applicant: Medivators Inc., Minneapolis, MN (US)

(72) Inventors: Huyen Bui, Brooklyn Park, MN (US); Terese M. Evans, Crystal, MN (US); John Matta, Shoreview, MN (US); Kristopher Murphy, New Brighton, MN (US); Tuan Nguyen, Chaska, MN (US)

(21) Appl. No.: 17/278,762

(22) PCT Filed: Sep. 26, 2019
(86) PCT No.: PCT/US2019/053090

§ 371 Date: Mar. 23, 2021

Related U.S. Application Data
(60) Provisional application No. 62/737,453, filed on Sep. 27, 2018.

(51) Int. Cl. A01N 25/22; A01N 59/00; A01N 37/16; A01N 25/02

(52) U.S. Cl. CPC A01N 25/22; A01N 59/00; A01N 25/30; A01N 25/02; A01N 37/16

(57) ABSTRACT

The invention describes to compositions useful to stabilize peracetic acid and hydrogen peroxide compositions with polymeric sulfonic acid resins and methods of their use.

### CROSS REFERENCE TO RELATED APPLICATIONS

This application claims priority to U.S. Provisional Ser. No. 62/737,453, filed on Sep. 27, 2018, the contents of which are expressly incorporated herein by reference for all purposes.

### FIELD OF THE INVENTION

The invention relates generally to methods to stabilize peracetic acid and hydrogen peroxide compositions with polymeric sulfonic acid resins.

### BACKGROUND OF THE INVENTION

A perfect disinfectant would offer complete and full microbiological sterilization, without harming humans and useful forms of life, be inexpensive, and non-corrosive. However, ideal disinfectants do not exist. Most disinfectants are also, by nature, potentially harmful (even toxic) to humans or animals.

The choice of disinfectant to be used depends on the particular situation. Some disinfectants have a wide spectrum (kill many different types of microorganisms), while others kill a smaller range of disease-causing organisms but are preferred for other properties (they may be non-corrosive, non-toxic, or inexpensive).

Peracetic acid and hydrogen peroxide compositions have been used to disinfect various surfaces including surfaces of instruments. However, contamination of the peracetic acid/hydrogen peroxide composition is commonplace by a user. Contamination of the peracetic acid/hydrogen peroxide composition causes degradation and instability of the composition.

A solution to the unstable nature/contamination of peracetic acid/hydrogen peroxide compositions has been addressed by use of 1-hydroxyethylidene-1,1,-diphosphonic acid, or 1-hydroxyethane 1,1-diphosphonic acid, or HEDP with a CAS Reg. No. of 2809-21-4 as a stabilizer. A disadvantage of the stabilizer is a residue left on the treated surface after the surface has dried. This can be critical when instruments, such as endoscopes, are used repeatedly. The residue can cause degradation of the surface of the instrument, thus reducing the useful life of the instrument, and ultimately increasing costs to the user since the instrument will need to be replaced more frequently. Additionally, the operators consider a residue of any type on an instrument, even if non-toxic, aesthetically unappealing.

Therefore, a need exists for sterilization composition that overcomes one or more of the current disadvantages noted above.

### BRIEF SUMMARY OF THE INVENTION

The present embodiments surprisingly provide a simple but elegant method to stabilize peracetic acid/hydrogen peroxide compositions without the need for a phosphonic based chelator, such as 1-hydroxyethylidene-1,1,-diphosphonic acid. The present embodiments provide compositions, which upon drying, do not leave a residue on the treated surface. This aspect is highly advantageous in view of current products in the market that leave a residue on the treated surface after drying.

In various embodiments, the present invention provides for a composition that includes: (a) hydrogen peroxide; (b) organic acid; (c) a polymeric sulfonic acid resin based chelator; and (d) surfactant. The composition includes less than about 1 wt. % of an anticorrosive agent. The composition can further optionally include water.

In one aspect, the hydrogen peroxide present in the composition can be from about 0.5 wt. % to about 30 wt. %, from about 0.5 wt. % to about 1.5 wt. %, from about 0.8 wt. % to about 1.2 wt. %, from about 0.9 wt. % to about 1.1 wt. %, from about 20 wt. % to about 30 wt. % and all ranges and values from about 0.5 wt. % to about 30 wt. %.

In another aspect, the acetic acid present in the composition can be from about 1 wt. % to about 25 wt. %, from about 4 wt. % to about 20 wt. %, from about 4.5 wt. % to about 5.5 wt. %, from about 9 wt. % to about 17 wt. % and all ranges and values from about 1 wt. % to about 25 wt. %.

In still another aspect, the peracetic acid present in the composition can be from about 0.01 wt. % to about 25 wt. %, from about 0.05 wt. % to about 20 wt. %, from about 0.05 wt. % to about 0.1 wt. %, from about 0.05 wt. % to about 0.11 wt. %, from about 3.5 wt. % to about 8 wt. % and all ranges and values from about 0.01 wt. % to about 25 wt. %.

In yet another aspect, the polymeric resin chelator present in the composition can be from about 0.1 wt. % to about 5 wt. %, from about 0.2 wt. % to about 2 wt. %, from about 0.5 wt. % to about 1.5 wt. % and all ranges and value from about 0.1 wt. % to about 5 wt. %.

In various embodiments, the present invention provides for a composition that includes: (a) hydrogen peroxide, present in a concentration of about 0.5 wt. % to about 30 wt. %, e.g., about 28 wt. %; (b) acetic acid, present in a concentration of about 3 wt. % to about 25 wt. %, e.g., about 16 wt. %; (c) a sulfonic acid supported polymeric resin chelator present in a concentration of about 0.1 wt. % to about 5 wt. %, e.g., about 0.2 wt. % to about 0.7 wt. %; and, optionally, (d) Pluronic® 10R5 surfactant block copolymer, present in a concentration of about 2.0 wt. %, wherein the composition comprises less than about 0.1 wt. % of an anticorrosive agent, e.g., 0 wt. % of an anticorrosive agent. The composition can further optionally include water. In some embodiments, the hydrogen peroxide and acetic acid can combine to form peracetic acid, present in about 4 wt. % to about 8 wt. %, e.g., 6.8-7.5 wt. %.

In various embodiments, the present invention provides for a method of reducing the number of microbes located upon a substrate. In some embodiments, the method includes contacting the substrate with an effective amount of a composition including hydrogen peroxide, organic acid, a polymeric resin chelator, and surfactant, wherein the composition comprises less than about 1 wt. % of an anticorrosive agent, for a sufficient period of time, effective to reduce the number of microbes located upon the substrate

The present embodiments also provide for a one part, liquid concentrate disinfectant or sterilant that includes: (a) about 10-65 wt. % hydrogen peroxide; (b) about 10-65 wt. % of an organic acid; (c) about 0.1-10 wt. % polymeric resin chelator; and, optionally, (d) about 0 wt. % to about 8 wt. %, e.g., 0.1 wt. % to about 8 wt. % surfactant and, optionally, 0 wt. % to about 2 wt. % anticorrosive agent, e.g., about 1 wt. % or less.

The present embodiments also provide for a one part, liquid concentrate disinfectant or sterilant composition that includes: (a) about 28 wt. % hydrogen peroxide (b) about 16 wt. % acetic acid; (c) about 0.1 wt. % to about 5 wt. % polymeric resin chelator; optionally, (d) about 2.0 wt. % Pluronic® 10R5 surfactant block copolymer and (e) about 53 wt. % deionized water. In some embodiments, the disinfectant or sterilant composition, at equilibrium, includes (a) about 20.0 to about 26.0 wt. % hydrogen peroxide, (b) about 9.0 to about 11.0 wt. % acetic acid, (c) about 0.1 wt. % to about 5 wt. % polymeric resin chelator; optionally, (d) about 2 wt. % Pluronic® 10R5 surfactant block copolymer (e) about 52.0 to about 62.0 wt. % deionized water and (f) about 4 to about 7.5 wt. % peracetic acid.

The present embodiments also provide for a kit that includes: (a) an enclosed container that includes a removable closure; (b) the composition as described herein, located inside the enclosed container, and (c) printed indicia located on the enclosed container.

The present embodiments also provide for a method of reducing the number of microbes located upon a substrate. In some embodiments, the method includes contacting the substrate with an effective amount of the compositions described herein, for a sufficient period of time, effective to reduce the number of microbes located upon the substrate.

The present embodiments also provide for a method of killing or inhibiting a microorganism. In some embodiments, the method includes contacting the microorganism with an antimicrobially effective amount of the composition described herein, for a sufficient period of time, effective to kill or inhibit the microorganism.

The present embodiments also provide for a method of disinfecting or sterilizing a substrate. In some embodiments, the method includes contacting the substrate with an effective amount of the compositions described herein, for a sufficient period of time, effective to disinfect or sterilize the substrate. The present embodiments also provide for a method of disinfecting or sterilizing a medical device. In some embodiments, a method of disinfecting or sterilizing an endoscopic device is achieved with the use of the compositions described herein.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

FIG. 1 provides a hydrogen peroxide stability study for PAA chemistry with different stabilizers and spiked with iron sulfate. Sample numbers correspond to the sample numbers in Table 1.

FIG. 2 provides a peroxyacetic acid stability study for PAA chemistry with different stabilizers and spiked with iron sulfate.

FIG. 3 demonstrates stability data of hydrogen peroxide for PAA chemistry without use of Dequest as a stabilizer for study #1.

FIG. 4 demonstrates stability data of peracetic acid for PAA chemistry without Dequest as a stabilizer for study #1.

FIG. 5 demonstrates stability data of hydrogen peroxide for PAA chemistry without use of Dequest as a stabilizer for study #2.

FIG. 6 demonstrates stability data of peracetic acid for PAA chemistry without Dequest as a stabilizer for study #2.

FIG. 7 demonstrates stability data of hydrogen peroxide for PAA chemistry without use of Dequest as a stabilizer for study #3.

FIG. 8 demonstrates stability data of peracetic acid for PAA chemistry without Dequest as a stabilizer for study #3.

FIG. 9 demonstrates stability data of hydrogen peroxide for PAA chemistry with Amberlite present (0.25% w/w), in a non-control sample, as a stabilizer for study #4.

FIG. 10 demonstrates stability data of peracetic acid for PAA chemistry with Amberlite present (0.25% w/w), in a non-control sample, as a stabilizer for study #4.

FIG. 11 demonstrates stability data of hydrogen peroxide for PAA chemistry with Amberlite present (0.5% w/w), in a non-control sample, as a stabilizer for study #5.

FIG. 12 demonstrates stability data of peracetic acid for PAA chemistry with Amberlite present (0.5% w/w), in a non-control sample, as a stabilizer for study #5.

FIG. 13 demonstrates stability data of hydrogen peroxide for PAA chemistry with Amberlite present (0.25% w/w), in a non-control sample, as a stabilizer for study #6.

FIG. 14 demonstrates stability data of peracetic acid for PAA chemistry with Amberlite present (0.25% w/w), in a non-control sample, as a stabilizer for study #6.

FIG. 15 provides stability curves of hydrogen peroxide for Experiment #3 with different stabilizers and different concentrations of iron sulfate as an impurity.

FIG. 16 provides stability curves of PAA for Experiment #3 with different stabilizers and different concentrations of iron sulfate as an impurity.

FIG. 17 shows Peracetic Acid Stability of the Controls, Aquivion E98-15S, and Aquivion E87-05S.

FIG. 18 shows Hydrogen Peroxide Stability of the Controls, Aquivion E98-15S, and Aquivion E87-05S

FIG. 19 shows Acetic Acid Stability of the Controls, Aquivion E98-15S, and Aquivion E87-05S.

FIG. 20 shows PAA concentrations for stability over a 12 month period for the various polymeric resins tested.

FIG. 21 shows H₂O₂ concentrations for stability over a 12 month period for the various polymeric resins tested.

FIG. 22 shows AA concentrations for stability over a 12 month period for the various polymeric resins tested.

### DETAILED DESCRIPTION

In the specification and in the claims, the terms “including” and “comprising” are open-ended terms and should be interpreted to mean “including, but not limited to . . . .” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” should be interpreted to include not only the explicitly recited amount of about 0.1 wt. % to about 5 wt. %, but also the individual concentrations (e.g., 1%, 2%, 3%, and 4%) and the sub-ranges (e.g., 0.5%, 1.1%, 2.2%, 3.3%, and 4.4%) within the indicated range.

When describing the present invention, the following terms have the following meanings, unless otherwise indicated.

The term “about” can allow for a degree of variability in a value or range, for example, within 10%, within 5%, or within 1% of a stated value or of a stated limit of a range.

The term “room temperature” as used herein refers to a temperature of about 15° C. to 28° C.

The term “hydrogen peroxide” or “H₂O₂” refers to the compound chemically designated as dihydrogen dioxide, having the CAS Reg. No. 7722-84-1. In specific embodiments of the invention, the hydrogen peroxide includes water. In further specific embodiments of the invention, the hydrogen peroxide is 50% wt. % hydrogen peroxide in water. The hydrogen peroxide can be present in the composition, in any suitable and effective amount.

The term “organic acid” refers to an organic compound with acidic properties. The most common organic acids are the carboxylic acids, whose acidity is associated with their carboxyl group —COOH. Sulfonic acids, containing the group —SO₂OH, are relatively stronger acids. The relative stability of the conjugate base of the acid determines its acidity. Other groups can also confer acidity, usually weakly: —OH, —SH, the enol group, and the phenol group. Organic compounds containing these groups are generally referred to as organic acids. An example of an organic acid is acetic acid.

The term “acetic acid” or “ethanoic acid” refers to an organic compound with the chemical formula CH₃CO₂H (also written as CH₃COOH), having the CAS Reg. No. 64-19-7.

The term “glacial acetic acid” refers to undiluted and relatively concentrated, water-free (anhydrous) acetic acid.

The term “peracetic acid,” “peroxyacetic acid,” or “PAA” refers to an organic compound with the chemical formula CH₃CO₃H.

The term “chelator,” “chelant” or “chelating agent” refers to a compound that forms soluble, complex molecules with certain metal ions, inactivating the metal ions (or to some extent, countering the effects of the metal ions), so that they cannot normally react with other compounds, elements or ions. In specific embodiments, the chelator effectively chelates transition metals. One suitable type of chelator is/are sulfonic acids, more particularly, polymers or solid supports which contain sulfonic acid functionality. In specific embodiments, the chelator will effectively chelate any transition metals and/or alkaline earth metals present in any of the components of the composition.

In particular, the chelator can be a sulfonic acid group that is incorporated into a polymer. For example, the polymer can be styrene based that is functionalized with sulfonic acid groups. The styrenic polymer can be a copolymer, such as styrene/divinylbenzene. The polymer may further be crosslinked. Examples of commercially available sulfonic acid functionalized polymers include those such as Dowex® 50WX4-200, Dowex® DR2030, Amberlite IR120 Na, Amberlite IRN99, Amberlyst 15 hydrogen (CAS Number 39389-20-3) and Amberlite strong acidic cation exchange sodium form available from Dow Chemical Company, which are styrene-divinylbenzene copolymers.

Alternatively, a copolymer of tetrafluoroethylene (TFE) and Sulfonyl Fluoride Vinyl Ether (SFVE) F₂C═CF—O—CF₂CF₂—SO₂F is a useful material. Aquivion® PFSA (perfluorosulfonic acid) ionomers, available from Solvay, are based on this copolymer or tetrafluoroethylene-perfluoro(3-oxa-4-pentenesulfonic acid) copolymers (e.g., [CF₂CF(OCF₂CF₂SO₃H)]ₘ[CF₂CF₂]ₙ, as Aquivion E98-15S, Aquivion E98-09S, Aquivion PW79S, or Aquivion E87-05S available from Sigma or Krackeler Scientific, Inc.). and are available in a membrane, as a powder, in a dispersion or as pellets. These are all perfluorosulfonic acid resins.

In one aspect, the perfluorosulfonic acid pellets can be extruded/coextruded with other polymers to form films or shaped into a container to hold the remaining components of the embodiments. Suitable extrusion polymers include, for example, polyethylenes, e.g., (high density polyethylene, HDPE) and polypropylenes.

In another embodiment, the polymer can be derived from 2-acrylamido-2-methylpropane sulfonic acid (AMPS). Additionally, AMPS can be used to coat the lining of a container and then be polymerized to the surface of the container as a protective/chelating coating.

It should be understood that the requisite sulfonic acid group may need to be first treated with an acidic solution to provide the free acid as necessary.

The polymeric resin chelator can be added to the compositions described herein. Alternatively, the compositions can be passed through the polymeric resin chelator. In another embodiment, the polymeric resin chelator can be in the form of a membrane and the membrane is in contact and remains in contact with the composition. In still another embodiment, the polymeric resin chelator is incorporated into a container which hold the compositions described herein. In certain embodiments, the polymer resin chelator is coated onto the interior of a container that is used to store the compositions described herein. In still another embodiment, the polymeric chelator can be placed within a “mesh pouch” or other containment system that can be placed into a container with the compositions described herein.

One advantage of utilizing the polymeric resin chelator is that users of the compositions often contaminate the composition in between uses. That is, an individual may place a used wipe, sponge, or rag, medical device, instrument, etc. against or within the container that houses the composition, thus transferring contaminants to the container. The polymeric resin chelators described herein help to stabilize the peracetic acid/hydrogen peroxide compositions by complexing with/removing the undesired contaminants, such as metal ions.

It should be understood that one advantage of the polymeric resin chelator is that it does not dissolve in the embodiments described herein. That is, the polymer resin remains in the solution but does not become homogeneous with the remaining components. Not to be limited by theory, it is believed that the polymeric resin chelator provides surface contact with the components of the composition and removes metallic contaminants from the solution to stabilize the composition. As a result, the components of the composition, e.g., the hydrogen peroxide and/or the peracetic acid, do not degrade over time due to metallic components. Additionally, the polymeric resin chelator does not cause a residue to remain on a treated surface after the surface has been treated with the compositions described herein.

The term “anticorrosive agent” or “corrosion inhibitor” refers to a compound that, when added to a liquid or gas, decreases the corrosion rate of a material, typically a metal or an alloy. Suitable anticorrosive agents include, e.g., benzotriazole and sodium dodecyl sulfate (SDS).

The term “benzotriazole” or “BTA” refers to the compound 1H-benzotriazole or 1,2,3-benzotriazole, having the CAS Reg. No. 95-14-7.

The term “surfactant” refers to a compound capable of lowering the surface tension of a liquid, the interfacial tension between two liquids, or that between a liquid and a solid. Surfactants may act as detergents, wetting agents, emulsifiers, foaming agents, and/or dispersants. The surfactant can be non-ionic, anionic or cationic. Additionally, the surfactant can include one or more non-ionic surfactants, one or more anionic surfactants, and/or one or more cationic surfactants.

The term “non-ionic surfactant” or “nonionic surfactant” refers to a surfactant, in which the total number of electrons is equal to the total number of protons, giving it a net neutral or zero electrical charge. One suitable class of non-ionic surfactants includes the Pluronic® poloxamers.

Poloxamers are nonionic triblock copolymers composed of a central hydrophobic chain of polyoxypropylene (poly(propylene oxide)) flanked by two hydrophilic chains of polyoxyethylene (poly(ethylene oxide)). Poloxamers are also known by the trade name Pluronics®.

Because the lengths of the polymer blocks can be customized, many different poloxamers exist, that have slightly different properties. For the generic term “poloxamer,” these copolymers are commonly named with the letter “P” (for poloxamer) followed by three digits, the first two digits “×” (times) 100 give the approximate molecular mass of the polyoxypropylene core, and the last digit×10 gives the percentage polyoxyethylene content (e.g., P407=Poloxamer with a polyoxypropylene molecular mass of 4,000 g/mol and a 70% polyoxyethylene content). For the Pluronic® tradename, coding of these copolymers starts with a letter to define its physical form at room temperature (L=liquid, P=paste, F=flake (solid)) followed by two or three digits. The first digit (two digits in a three-digit number) in the numerical designation, multiplied by 300, indicates the approximate molecular weight of the hydrophobe; and the last digit×10 gives the percentage polyoxyethylene content (e.g., L61=Pluronic with a polyoxypropylene molecular mass of 1,800 g/mol and a 10% polyoxyethylene content). In the example given, poloxamer 181 (P181)=Pluronic L61.

The term “Pluronic® 10R5 surfactant block copolymer” refers to polyoxypropylene-polyoxyethylene block copolymer, having the CAS Reg. No. 9003-11-6.

Other nonionic surfactants include, but are not limited to, fatty alcohols, polyoxyethylene glycol alkyl ethers (Brij), polyoxypropylene glycol alkyl ethers, glucoside alkyl ethers, polyoxyethylene glycol octylphenol ethers, polyoxyethylene glycol alkylphenol ethers, glycerol alkyl esters, polyoxyethylene glycol sorbitan alkyl esters, sorbitan alkyl esters, cocamide MEAs, cocamide DEAs, dodecyl dimethylamine oxides, block copolymers of polyethylene glycol and polypropylene glycols.

Suitable fatty alcohols include, but are not limited to, cetyl alcohol, stearyl alcohol, cetostearyl alcohol (consisting predominantly of cetyl and stearyl alcohols) and oleyl alcohol.

Suitable polyoxyethylene glycol alkyl ethers, include but are not limited to (Brij), for example CH₃—(CH₂)₁₀₋₁₆—(O—C₂H₄)₁₋₂₅—OH, or octaethylene glycol monododecyl ether or pentaethylene glycol monododecyl ether.

Suitable polyoxypropylene glycol alkyl ethers include CH₃—(CH₂)₁₀₋₁₆—(O—C₃H₆)₁₋₂₅—OH.

Suitable glucoside alkyl ethers include CH₃—(CH₂)₁₀₋₁₆—(O-Glucoside)₁₋₃-OH, and, for example, include decyl glucoside, lauryl glucoside, and octyl glucoside.

Suitable polyoxyethylene glycol octylphenol ethers include C₈H₁₇—(C₆H₄)—(O—C₂H₄)₁₋₂₅—OH. One exemplary material is TRITON X-100.

Suitable polyoxyethylene glycol alkylphenol ethers include C₉H₁₉—(C₆H₄)—(O—C₂H₄)₁₋₂₅—OH. One example is Nonoxynol-9.

In one aspect, a suitable glycerol alkyl ester is glyceryl laurate.

In another aspect, a suitable polyoxyethylene glycol sorbitan alkyl ester is polysorbate.

In still another aspect, suitable sorbitan alkyl esters are referred to as SPAN, e.g., SPAN-20, sorbitan monolaurate.

The term “cationic surfactant” refers to a surfactant, in which the total number of electrons is less than the total number of protons, giving it a net positive electrical charge.

One kind of cationic surfactant is typically based on pH-dependent primary, secondary or tertiary amines. The primary amines become positively charged at a pH<10, and the secondary amines become charged at a pH<4. One example is octenidine dihydrochloride.

Another type of cationic surfactant is based on permanently charged quaternary ammonium cations, such as alkyltrimethylammonium salts. These include but are not limited to cetyl trimethylammonium bromide (CTAB), hexadecyl trimethyl ammonium bromide, cetyl trimethylammonium chloride (CTAC), cetylpyridinium chloride (CPC), polyethoxylated tallow amine (POEA), benzalkonium chloride (BAC), benzethonium chloride (BZT), 5-Bromo-5-nitro-1,3-dioxane, dimethyldioctadecylammonium chloride and dioctadecyldimethylammonium bromide (DODAB).

The term “anionic surfactant” refers to a surfactant in which the total number of electrons is greater than the total number of protons, giving it a net negative electrical charge. One suitable anionic surfactant is sodium lauryl sulfate.

Anionic surfactants have a permanent anion, such as a sulfate, sulfonate or phosphate anion associated with the surfactant or has a pH-dependent anion, for example, a carboxylate.

Sulfates can be alkyl sulfate or alkyl ether sulfates.

Suitable alkyl sulfates include, but are not limited to, ammonium lauryl sulfate or sodium lauryl sulfate (SDS). Suitable alkyl ether sulfates include, but are not limited to, sodium laureth sulfate, also known as sodium lauryl ether sulfate (SLES) or sodium myreth sulfate.

Suitable sulfonates include, but are not limited to, docusate (dioctyl sodium sulfosuccinate), fluorosurfactants that are sulfonated and alkyl benzene sulfonates.

Typical sulfonated fluorosurfactants include, but are not limited to, perfluorooctanesulfonate (PFOS) or perfluorobutanesulfonate.

Phosphates are typically alkyl aryl ether phosphates or alkyl ether phosphates.

Carboxylates are typically alkyl carboxylates, such as fatty acid salts (soaps), such as for example, sodium stearate. Alternatively, the carboxylate can be, but is not limited to, sodium lauryl sarcosinate. In another alternative aspect, the carboxylate includes but is not limited to a carboxylated fluorosurfactant, such as perfluorononanoate, or perfluorooctanoate (PFOA or PFO).

When a single surfactant molecule exhibits both anionic and cationic dissociations it is called amphoteric or zwitterionic. Zwitterionic (amphoteric) surfactant is based on primary, secondary or tertiary amines or quaternary ammonium cation also having a sulfonate, carboxylate or a phosphate.

Suitable zwitterionic surfactants include, but are not limited to, CHAPS (3-[(3-Cholamidopropyl)dimethylammonio]-1-propanesulfonate) or a sultaine. The sultaine is typically cocamidopropyl hydroxysultaine.

In one aspect, the carboxylate cation is an amino acid, imino acid or betaine. In one aspect, the betaine is typically cocamidopropyl betaine.

When the zwitterionic surfactant includes a phosphate, lecithin is often chosen as the counterion.

The term “sodium dodecyl sulfate,” “SDS,” “NaDS,” “sodium lauryl sulfate,” or “SLS” refers to an organic compound with the formula CH₃(CH₂)₁₁OSO₃Na), having the CAS Reg. No. 151-21-3.

The term “disinfectant” refers to a substance that when applied to non-living objects, destroys microorganisms that are living on the objects. The term “disinfect” refers to the process of destruction or prevention of biological contaminants. Disinfection does not necessarily kill all microorganisms, especially nonresistant bacterial spores; it is less effective than sterilization, which is an extreme physical and/or chemical process that kills all types of life.

Disinfectants are different from other antimicrobial agents such as antibiotics, which destroy microorganisms within the body, and antiseptics, which destroy microorganisms on living tissue. Disinfectants are also different from biocides. The latter are intended to destroy all forms of life, not just microorganisms. Sanitizers are substances that simultaneously clean and disinfect.

The term “sterilant” (via sterilization) refers to a substance that when applied to non-living objects, destroys all viable forms of microbial life, when used according to labeling.

The term “CFU” refers colony forming units and is a measure of viable cells in which a colony represents an aggregate of cells derived from a single progenitor cell.

In various embodiments, the composition includes: (a) hydrogen peroxide; (b) an organic acid; (c) a chelator that is not Dequest® 2010 (1-hydroxyethylidene-1,1,-diphosphonic acid), in particular a sulfonic acid containing polymer, copolymer or a support functionalized with sulfonic acid groups; and (d) surfactant.

It should be understood that certain embodiments disclosed herein do not include 1-hydroxyethylidene-1,1,-diphosphonic acid. In embodiments disclosed herein, the compositions and methods do not leave a residue on a treated surface after use of the composition to treat the surface.

It is appreciated that those of ordinary skill in the art fully understand and appreciate that when a composition includes more than one component, the composition may also include additional components formed as a product of the reaction between the components in the composition. For example, those of skill in the art fully understand and appreciate that a composition including hydrogen peroxide (H₂O₂) and acetic acid (CH₃CO₂H) also includes the oxidized product of acetic acid, peracetic acid (CH₃CO₃H). As such, reference to the composition including hydrogen peroxide (H₂O₂) and acetic acid (CH₃CO₂H) is proper, as well as reference to the composition being formed from hydrogen peroxide (H₂O₂) and acetic acid (CH₃CO₂H). To that end, a composition of acetic acid and hydrogen peroxide will include significant and appreciable amounts of peracetic acid formed from the reaction of acetic acid with hydrogen peroxide. Further, it is appreciated that those of ordinary skill in the art fully understand and appreciate that an equilibrium exists between hydrogen peroxide and acetic acid, and peracetic acid.

In various embodiments, peracetic acid is present in about 1 wt. % to about 15 wt. % of the composition. In some embodiments, peracetic acid is present in about 2-14 wt. %, 3-12 wt. %, 4-11 wt. %, 5-9 wt. %, about 6-8 wt. %, or about 1 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, or about 15 wt. % or more of the composition. In some embodiments, peracetic acid is present in about 5 wt. % to about 7.5 wt. % of the composition.

In various embodiments, hydrogen peroxide is present in about 10 wt. % to about 50 wt. % of the composition. In some embodiments (e.g., before equilibration and formation of PAA), the hydrogen peroxide is present in about 15-45 wt. %, 20-35 wt. %, or about 25-30 wt. % of the composition. In some embodiments (e.g., after equilibration and formation of PAA), the hydrogen peroxide is present in about 10-40 wt. %, 15-35 wt. %, 18-30 wt. % or about 20-26 wt. % of the composition. In some embodiments, the hydrogen peroxide is present in about 16 wt. %, 18 wt. %, 20 wt. %, 21 wt. %, 22 wt. %, 23 wt. %, 24 wt. %, 25 wt. %, 26 wt. %, 27 wt. %, 28 wt. %, 29 wt. %, 30 wt. %, 31 wt. %, 32 wt. %, 34 wt. %, or about 36 wt. %. In some embodiments, the hydrogen peroxide is about 35 wt. % in water, present in about 18 wt. % to about 32 wt. % of the composition. In some embodiments, hydrogen peroxide is about 35 wt. % in water, present in about 28 wt. % of the composition. In some embodiments, hydrogen peroxide is about 35 wt. % in water, present in about 20 wt. % to about 26 wt. % of the composition.

In various embodiments, the organic acid includes acetic acid. In some embodiments, the organic acid comprises glacial acetic acid. In some embodiments, the organic acid includes acetic acid, present in at least about 3 wt. % of the composition. In some embodiments (e.g., before equilibration and formation of PAA), the organic acid includes acetic acid, present in about 1-50 wt. %, 2-45 wt. %, 3-40 wt. %, 4-35 wt. %, 6-30 wt. %, 8-24 wt. %, 10-22 wt. %, 12-20 wt. %, about 14-18 wt. %, or about 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, or about 25 wt. % of the composition. In some embodiments (e.g., after equilibration and formation of PAA), the organic acid includes acetic acid, present in about 1-20 wt. %, 2-18 wt. %, 3-17 wt. %, 4-16 wt. %, 5-15 wt. %, 6-14 wt. %, 7-13 wt. %, 8-12 wt. %, or about 9-11 wt. % of the composition. In some embodiments, the organic acid includes acetic acid, present in about 9 wt. % to about 11 wt. % of the composition. In some embodiments, the organic acid comprises acetic acid, present in about 16 wt. % of the composition.

In various embodiments, the chelator effectively chelates transition metals. In some embodiments the chelator includes a polymeric sulfonic acid resin.

In various embodiments, the surfactant includes a non-ionic surfactant. In various embodiments, the surfactant includes at least one of an anionic and cationic surfactant. In some embodiments the surfactant includes Pluronic® 10R5 surfactant block copolymer. In some embodiments the surfactant includes Pluronic® 10R5 surfactant block copolymer, present in at least about 0.1 wt. % of the composition. In some embodiments, the surfactant includes Pluronic® 10R5 surfactant block copolymer, present in about 0.1-8.0 wt. %, 0.3-7.0 wt. %, 0.5-6.0 wt. %, 0.7-5.0 wt. %, 0.8-4.0 wt. %, about 1.0-3.0 wt. %, or about 0.5 wt. %, 1.0 wt. %, 1.4 wt. %, 1.8 wt. %, 2.0 wt. %, 2.2 wt. %, 2.6 wt. %, or about 3.0 wt. % of the composition. In some embodiments, the surfactant includes Pluronic® 10R5 surfactant block copolymer, present in about 2 wt. % of the composition.

In various embodiments, the composition includes about 28 wt. % hydrogen peroxide, about 16 wt. % acetic acid, about 0.2 wt. % to about 2 wt. % polymeric resin chelator, optionally, about 2.0 wt. % Pluronic® 10R5 surfactant block copolymer, and about 53 wt. % deionized water.

In various embodiments, the composition includes about 20.0 to about 26.0 wt. % hydrogen peroxide, about 9.0 to about 11.0 wt. % acetic acid, about 0.2 wt. % to about 2 wt. % polymeric resin chelator, optionally, about 2.0 wt. % Pluronic® 10R5 surfactant block copolymer, about 53 wt. % deionized water and about 6.8 to about 7.5 wt. % peracetic acid.

In specific embodiments, the composition of the present invention can be formulated as, can exist as, and can be commercially available as a liquid concentrate disinfectant or sterilant. The term “liquid concentrate” refers to a composition that is relatively undiluted and concentrated, having a low content of carrier, e.g., water. Having the composition be commercially available as a liquid concentrate will typically save costs associated with the manufacturing, shipping, and/or storage of the product.

When the composition of the present invention is formulated as a liquid concentrate, the concentrate can subsequently be diluted with an appropriate amount of carrier (e.g., water) prior to use. Additionally, although considered to be a concentrate, when the composition of the present invention is formulated as a liquid concentrate, a discrete and finite amount of carrier (e.g., water) can be employed.

In various embodiments, the present invention provides for a one part, liquid concentrate disinfectant or sterilant including about 20.0 about 26.0 wt. % hydrogen peroxide, about 9.0 to about 11.0 wt. % acetic acid, about 0.2 wt. % to about 2 wt. % polymeric resin chelator, about 2.0 wt. % Pluronic® 10R5 surfactant block copolymer, about 53 wt. % deionized water and about 6.8 to about 7.5 wt. % peracetic acid.

The composition of the present invention can be formulated for application, depending upon the user's preference as well as the ultimate application of the composition. For example, the composition can be formulated for use in a sprayable composition, atomized liquid sprayer, or liquid applicator. Such formulations can include at least one of a spray bottle, motorized sprayer, wipe, cloth, sponge, non-woven fabric, and woven fabric. Such formulations may be particularly suitable for applying the composition to a surface of a hospital, physician's office, medical clinic, medical facility, dental office, dental facility, airport, school, pet store, zoo, children's day care, elderly nursing home, museum, movie theatre, athletic facility, sporting arena, gymnasium, rest room, bathroom, shopping center, amusement park, church, synagogue, mosque, temple, restaurant, food processing facility, food manufacturing facility, pharmaceutical company, hot-tub, sauna, and/or clean room.

Such liquid formulations may be particularly suitable for applying the composition to metal, plastic, natural rubber, synthetic rubber, glass, stone, grout, fiberglass, wood, concrete, construction products, and/or building products.

In various embodiments, the composition of the invention can be configured for use in contacting at least one of medical equipment, medical device (e.g., reusable medical device or instrument, such as an endoscope), surface in the medical industry, dental equipment, dental device, and surface in the dental industry. In some embodiments, the composition of the invention may be used in the reconditioning of a soiled endoscopic device. In some embodiments, the compositions of the invention are useful during the disinfection step or sterilization step of the high level disinfection cleaning process following use of the endoscope in a medical procedure. The term “endoscopic device” includes a plurality of minimally invasive surgical devices (e.g., scopes) that have been developed for specific uses. For example, upper and lower endoscopes are utilized for accessing the esophagus/stomach and the colon, respectively, angio scopes are utilized for examining blood vessels, and laparoscopes are utilized for examining the peritoneal cavity.

In some embodiments, catalysts for the formation of peracetic acid from hydrogen peroxide and acetic acid are employed. Suitable catalysts include, for example, inorganic acids, such as sulfuric acid (H₂SO₄), hydrochloric acid (HCl), phosphoric acid (H₃PO₄), and nitric acid (HNO₃).

In specific embodiments, the composition of the present invention can be non-corrosive. The term “non-corrosive” or “noncorrosive” refers to a substance that will not destroy or irreversibly damage another surface or substance with which it comes into contact. The main hazards to people include damage to the eyes, the skin, and the tissue under the skin; inhalation or ingestion of a corrosive substance can damage the respiratory and gastrointestinal tracts. Exposure results in chemical burn. Having the composition be relatively non-corrosive will allow the user to employ the composition over a wider range of uses, exposing the composition to a wider range of substrates. For example, having the composition be relatively non-corrosive will allow the user to employ the composition as a disinfectant or sterilant with certain medical devices that are highly sensitive to corrosive substances.

In specific embodiments, the composition of the present invention can be non-toxic. The term “non-toxic” refers to a substance that has a relatively low degree to which it can damage a living or non-living organism. Toxicity can refer to the effect on a whole organism, such as an animal, bacterium, or plant, as well as the effect on a substructure of the organism, such as a cell (cytotoxicity) or an organ (organotoxicity), such as the liver (hepatotoxicity). A central concept of toxicology is that effects are dose-dependent; even water can lead to water intoxication when taken in large enough doses, whereas for even a very toxic substance such as snake venom there is a dose below which there is no detectable toxic effect. Having the composition be relatively non-toxic will allow a wider range of users be able to safely handle the composition, without serious safety concerns or risks.

In specific embodiments, the composition of the present invention can be stable over extended periods of time (i.e., has a long-term stability). The term “long-term stability” refers to a substance undergoing little or no physical and/or chemical decomposition or degradation, over extended periods of time.

In further specific embodiments, the composition of the present invention can be stable over extended periods of time, such that at about 1 atm and about 19° C., less than about 20 wt. %, e.g., 15 wt. %, 10 wt. %, or 5 wt. %, of each component independently degrades over about one year. In additional specific embodiments, the composition of the present invention can be stable over extended periods of time, such that at about 1 atm and about 19° C., at least about 80 wt. % of each component, e.g., 85 wt. %, 90 wt. %, 95 wt. %, is independently present after about one year.

Having the composition be relatively stable over extended periods of time will allow the composition to retain its effectiveness over that time, ensuring that it will remain useful and active for its intended purpose. In contrast, in those compositions that do not retain their effectiveness over that time, product loss can result, which can be financially costly. Additionally, risks associated with the use of a product that has lost some or all of its effectiveness for the intended purpose can be hazardous, in that the product may not effectively achieve the desired goal. For example, when used to disinfect or sterilize a medical device, use of a composition that has lost some or all of its effectiveness as a disinfectant or sterilant may not effectively disinfect or sterilize the medical device. Medical injuries can be sustained by the patient, including serious infections.

In specific embodiments, the composition of the present invention can be formulated as, can exist as, and is commercially available as, a one-part composition. The term “one-part composition” refers to all chemical components of a composition being present together, such that they are each in intimate and physical contact with one another, and are each present in a single container. Having the composition be commercially available as a one-part composition will be more cost effective (e.g., lower manufacturing costs associated with fewer containers), and will avoid the necessity of the user mixing or combining multiple components together, prior to using.

In specific embodiments, the composition of the present invention can be essentially free of buffer. In further specific embodiments, the composition of the present invention can include less than about 0.1 wt. % buffer. The term “buffer,” “buffering agent,” or “buffering substance” refers to a weak acid or base used to maintain the acidity (pH) of a solution at a chosen value. The function of a buffering agent is to prevent a rapid change in pH when acids or bases are added to the solution. Buffering agents have variable properties—some are more soluble than others; some are acidic while others are basic.

In specific embodiments, the composition of the present invention can be essentially free of transition metals. In further specific embodiments, the composition of the present invention can include less than about 0.001 wt. % transition metals. In further specific embodiments, the composition of the present invention can include less than about 0.0001 wt. % transition metals. In further specific embodiments, the composition of the present invention can include less than about 0.00001 wt. % transition metals. Having the composition include a minimal amount of transition metals decreases the likelihood that the transition metals will cause degradation and/or decomposition of the composition, over the extended periods of time associates with the manufacturing, shipping, and storage of the composition. This is especially so when the composition is formulated as a concentrated, one-part composition.

The term “transition metal,” “transition metals” or “transition element” refers to an element whose atom has an incomplete d sub-shell, or which can give rise to cations with an incomplete d sub-shell. Transition metals include scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (db), seaborgium (Sg), bohrium (Bh), hassium (Hs) and copernicium (Cn).

In specific embodiments of the invention, the transition metal can be naturally occurring. Naturally occurring transition metals include scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), and mercury (Hg).

In specific embodiments, the composition of the present invention can be essentially free of heavy metals. In further specific embodiments, the composition of the present invention can include less than about 0.001 wt. % heavy metals. In further specific embodiments, the composition of the present invention can include less than about 0.0001 wt. % heavy metals. In further specific embodiments, the composition of the present invention can include less than about 0.00001 wt. % heavy metals. Having the composition include a minimal amount of heavy metals decreases the likelihood that the transition metals will cause degradation and/or decomposition of the composition, over the extended periods of time associates with the manufacturing, shipping, and storage of the composition. This is especially so when the composition is formulated as a concentrated, one-part composition.

The term “heavy metal,” “heavy metals” or “toxic metal” refers to metals that are relatively toxic, and mainly include the transition metals, some metalloids, lanthanides, and actinides. Examples of toxic metals include, e.g., iron (Fe), cobalt (Co), copper (Cu), manganese (Mn), molybdenum (Mo), zinc (Zn), mercury (Hg), plutonium (Pu), lead (Pb), vanadium (V), tungsten (W), cadmium (Cd), aluminium (Al), beryllium (Be), and arsenic (As).

The present invention also provides for a kit that includes: (a) an enclosed container that includes a removable closure; (b) the composition of the present invention as described herein, which is located inside the enclosed container; and (c) printed indicia located on the enclosed container.

In specific embodiments, the enclosed container can be opaque. In additional specific embodiments, the enclosed container can be manufactured from high density polyethylene (HDPE), thereby providing the requisite opacity. Having the enclosed container be manufactured from high density polyethylene (HDPE) will decrease the likelihood that the composition will degrade and/or decompose over extended periods of time, due to excessive exposure to direct sunlight.

The term “high-density polyethylene” or “HDPE” refers to a polyethylene thermoplastic made from petroleum. The mass density of high-density polyethylene can range from 0.93 to 0.97 g/cm³. Although the density of HDPE is only marginally higher than that of low-density polyethylene, HDPE has little branching, giving it stronger intermolecular forces and tensile strength than LDPE. The difference in strength exceeds the difference in density, giving HDPE a higher specific strength. It is also harder and more opaque and can withstand somewhat higher temperatures (120° C./248° F. for short periods, 110° C./230° F. continuously). HDPE is resistant to many different solvents.

The term “solvent” as used herein refers to a liquid that can dissolve a solid, liquid, or gas. Non-limiting examples of solvents are silicones, organic compounds, water, alcohols, ionic liquids, and supercritical fluids.

The term “opaque” refers to an object that is neither transparent (allowing all light to pass through) nor translucent (allowing some light to pass through). When light strikes an interface between two substances, in general some may be reflected, some absorbed, some scattered, and the rest transmitted (also see refraction). Reflection can be diffuse, for example light reflecting off a white wall, or specular, for example light reflecting off a mirror. An opaque substance transmits no light, and therefore reflects, scatters, or absorbs all of it. Both mirrors and carbon black are opaque. Opacity depends on the frequency of the light being considered. For instance, some kinds of glass, while transparent in the visual range, are largely opaque to ultraviolet light. More extreme frequency-dependence is visible in the absorption lines of cold gases.

To further decrease the likelihood that the composition will degrade and/or decompose over extended periods of time, the composition should avoid, when feasible: excessive exposure to direct sunlight, excessive heat and/or elevated temperatures. As such, in specific embodiments, the enclosed container of the kit can include printed indicia, with instructions to avoid excessive heat, elevated temperatures, direct sunlight, or a combination thereof.

Over extended periods of time, hydrogen peroxide and/or peracetic acid present in the composition will be susceptible to degrade or decompose (and a portion of the hydrogen peroxide may degrade or decompose), thereby evolving oxygen.

In specific embodiments, the enclosed container includes a head space, pressure valve, or combination thereof. In specific embodiments, the enclosed container includes a pressure valve, configured to release excessive gas from within the enclosed container. The presence of a head space and pressure valve in the container will allow for the escape of gas (e.g., oxygen) from the enclosed container, without the likelihood that the container will explode from the elevated pressure that would otherwise develop.

The term “head space” refers to a portion of the inside of a container that is not occupied by the liquid contents of the container. In particular, when a container includes a liquid composition, a head space can be present in the container such that a portion of the inside of the container does not include liquid composition, but instead includes a gas or vacuum. In specific embodiments, the head space can include oxygen (02), peracetic acid and/or acetic acid vapor. In further specific embodiments, the head space can be present in up to about 20% (v/v) of the inside of the enclosed container.

The term “pressure valve” refers to a mechanical device that will permit for the passage of gas and not fluid, preferably in one direction only, for example, exiting a container housing the pressure valve, and not entering the container.

The composition of the present invention can be used to effectively reduce the number of microbes located upon a substrate. In specific embodiments, the composition can effectively kill and/or inhibit a microorganism (e.g., virus, fungus, mold, slime mold, algae, yeast, mushroom and/or bacterium), thereby disinfecting or sterilizing the substrate.

In additional specific embodiments, the composition can effectively sanitize a substrate, thereby simultaneously cleaning and disinfecting and/or sterilizing the substrate. In additional specific embodiments, the composition can effectively kill or inhibit all forms of life, not just microorganisms, thereby acting as a biocide.

In specific embodiments, the composition can effectively disinfect or sterilize a substrate. In further specific embodiments, the composition can effectively disinfect or sterilize the surface of a substrate. In additional specific embodiments, the composition can effectively sterilize a substrate. In further specific embodiments, the composition can effectively sterilize the surface of a substrate.

The term “microbe,” “microbes” “microorganism,” or “micro-organism” refers to a microscopic organism that comprises either a single cell (unicellular), cell clusters, or no cell at all (acellular). Microorganisms are very diverse; they include bacteria, fungi, archaea, and protists; microscopic plants (green algae); and animals such as plankton and the planarian. Some microbiologists also include viruses, but others consider these as non-living. Most microorganisms are unicellular (single-celled), but this is not universal, since some multicellular organisms are microscopic, while some unicellular protists and bacteria, like Thiomargarita namibiensis, are macroscopic and visible to the naked eye.

The term “virus” refers to a small infectious agent that can replicate only inside the living cells of organisms. Virus particles (known as virions) consist of two or three parts: the genetic material made from either DNA or RNA, long molecules that carry genetic information; a protein coat that protects these genes; and in some cases an envelope of lipids that surrounds the protein coat when they are outside a cell. The shapes of viruses range from simple helical and icosahedral forms to more complex structures. The average virus is about one one-hundredth the size of the average bacterium. An enormous variety of genomic structures can be seen among viral species; as a group they contain more structural genomic diversity than plants, animals, archaea, or bacteria. There are millions of different types of viruses, although only about 5,000 of them have been described in detail. A virus has either DNA or RNA genes and is called a DNA virus or a RNA virus respectively. The vast majority of viruses have RNA genomes. Plant viruses tend to have single-stranded RNA genomes and bacteriophages tend to have double-stranded DNA genomes.

The term “fungi” or “fungus” refers to a large and diverse group of eucaryotic microorganisms whose cells contain a nucleus, vacuoles, and mitochondria. Fungi include algae, molds, yeasts, mushrooms, and slime molds. See, Biology of Microorganisms, T. Brock and M. Madigan, 6th Ed., 1991, Prentice Hill (Englewood Cliffs, N.J.). Exemplary fungi include Ascomycetes (e.g., Neurospora, Saccharomyces, Morchella), Basidiomycetes (e.g., Amanita, Agaricus), Zygomycetes (e.g., Mucor, Rhizopus), Oomycetes (e.g., Allomyces), and Deuteromycetes (e.g., Penicillium, Aspergillus).

The term “mold” refers to a filamentous fungus, generally a circular colony that may be cottony, wooly, etc. or glabrous, but with filaments not organized into large fruiting bodies, such as mushrooms. See, e.g., Stedman's Medical Dictionary, 25th Ed., Williams & Wilkins, 1990 (Baltimore, Md.). One exemplary mold is the Basidiomycetes called wood-rotting fungi. Two types of wood-rotting fungi are the white rot and the brown rot. An ecological activity of many fungi, especially members of the Basidiomycetes is the decomposition of wood, paper, cloth, and other products derived from natural sources. Basidiomycetes that attack these products are able to utilize cellulose or lignin as carbon and energy sources. Lignin is a complex polymer in which the building blocks are phenolic compounds. It is an important constituent of woody plants. The decomposition of lignin in nature occurs almost exclusively through the agency of these wood-rotting fungi. Brown rot attacks and decomposes the cellulose and the lignin is left unchanged. White rot attacks and decomposes both cellulose and lignin. See, Biology of Microorganisms, T. Brock and M. Madigan, 6th Ed., 1991, Prentice Hill (Englewood Cliffs, N.J.).

The term “slime molds” refers to nonphototrophic eucaryotic microorganisms that have some similarity to both fungi and protozoa. The slime molds can be divided into two groups, the cellular slime molds, whose vegetative forms are composed of single amoebalike cells, and the acellular slime molds, whose vegetive forms are naked masses of protoplasms of indefinite size and shape called plasmodia. Slime molds live primarily on decaying plant matter, such as wood, paper, and cloth. See, Biology of Microorganisms, T. Brock and M. Madigan, 6th Ed., 1991, Prentice Hill (Englewood Cliffs, N.J.).

The term “algae” refers to a large and diverse assemblage of eucaryotic organisms that contain chlorophyll and carry out oxygenic photosynthesis. See, Biology of Microorganisms, T. Brock and M. Madigan, 6th Ed., 1991, Prentice Hill (Englewood Cliffs, N.J.). Exemplary algae include Green Algae (e.g., Chlamydomonas), Euglenids (e.g., Euglena), Golden Brown Algae (e.g., Navicula), Brown Algae (e.g., Laminaria), Dinoflagellates (e.g., Gonyaulax), and Red Algae (e.g., Polisiphonia).

The term “yeast” refers to unicellular fungi, most of which are classified with the Ascomytes. See, Biology of Microorganisms, T. Brock and M. Madigan, 6th Ed., 1991, Prentice Hill (Englewood Cliffs, N.J.).

The term “mushrooms” refer to filamentous fungi that are typically from large structures called fruiting bodies, the edible part of the mushroom. See, Biology of Microorganisms, T. Brock and M. Madigan, 6th Ed., 1991, Prentice Hill (Englewood Cliffs, N.J.).

The term “bacterium” or “bacteria” refers to a large domain of prokaryotic microorganisms. Typically a few micrometers in length, bacteria have a wide range of shapes, ranging from spheres to rods and spirals. Bacteria are present in most habitats on Earth, growing in soil, acidic hot springs, radioactive waste, water, and deep in the Earth's crust, as well as in organic matter and the live bodies of plants and animals, providing outstanding examples of mutualism in the digestive tracts of humans, termites and cockroaches. There are typically about 40 million bacterial cells in a gram of soil and a million bacterial cells in a milliliter of fresh water; in all, there are approximately five nonillion (5×10³⁰) bacteria on Earth, forming a biomass that exceeds that of all plants and animals. Most bacteria have not been characterized, and only about half of the phyla of bacteria have species that can be grown in the laboratory.

The term “P. aeruginosa” or “Pseudomonas aeruginosa” refers to a common bacterium that can cause disease in animals, including humans. It is found in soil, water, skin flora, and most man-made environments throughout the world. It thrives not only in normal atmospheres, but also in hypoxic atmospheres, and has, thus, colonized many natural and artificial environments. It uses a wide range of organic material for food; in animals, the versatility enables the organism to infect damaged tissues or those with reduced immunity. The symptoms of such infections are generalized inflammation and sepsis. If such colonizations occur in critical body organs, such as the lungs, the urinary tract, and kidneys, the results can be fatal. Because it thrives on most surfaces, this bacterium is also found on and in medical equipment, including catheters, causing cross-infections in hospitals and clinics. It is implicated in hot-tub rash.

The term “S. aureus” or “Staphylococcus aureus” refers to a facultative anaerobic Gram-positive bacterium. It is frequently found as part of the normal skin flora on the skin and nasal passages. It is estimated that 20% of the human population are long-term carriers of S. aureus. S. aureus is the most common species of staphylococci to cause Staph infections. The reasons S. aureus is a successful pathogen are a combination host and bacterial immuno-evasive strategies. One of these strategies is the production of carotenoid pigment staphyloxanthin which is responsible for the characteristic golden color of S. aureus colonies. This pigment acts as a virulence factor, primarily being a bacterial antioxidant which helps the microbe evade the host's immune system in the form of reactive oxygen species which the host uses to kill pathogens.

S. aureus can cause a range of illnesses from minor skin infections, such as pimples, impetigo, boils (furuncles), cellulitis folliculitis, carbuncles, scalded skin syndrome, and abscesses, to life-threatening diseases such as pneumonia, meningitis, osteomyelitis, endocarditis, toxic shock syndrome (TSS), bacteremia, and sepsis. Its incidence is from skin, soft tissue, respiratory, bone, joint, endovascular to wound infections. It is still one of the five most common causes of nosocomial infections, often causing postsurgical wound infections. Each year, some 500,000 patients in American hospitals contract a staphylococcal infection.

Methicillin-resistant S. aureus, abbreviated MRSA and often pronounced “mer-sa” (in North America), is one of a number of greatly-feared strains of S. aureus which have become resistant to most antibiotics. MRSA strains are most often found associated with institutions such as hospitals, but are becoming increasingly prevalent in community-acquired infections.

The term “E. hirae” or “Enterococcus hirae” refers to a species of Enterococcus.

The term “M. terrae” or “Mycobacterium terrae” refers to a slow-growing species of Mycobacterium. It is an ungrouped member of the third Runyon (nonchromatogenic mycobacteria). It is known to cause serious skin infections, which are relatively resistant to antibiotic therapy

The term “Mycobacterium avium complex,” “M. avium complex” or “MAC” refers to a group of genetically related bacteria belonging to the genus Mycobacterium. It includes Mycobacterium avium and Mycobacterium intracellulare.

The term “M. avium” or “Mycobacterium avium” refers to a species of Mycobacterium.

The term “M. intracellulare” or “Mycobacterium intracellulare” refers to a species of Mycobacterium.

The invention will now be described by the following non-limiting examples.

The following paragraphs enumerated consecutively from 1 through 106 provide for various aspects of the present invention. In one embodiment, in a first paragraph (1), the present invention provides a method to stabilize a peracetic acid and hydrogen peroxide solution comprising the step:

contacting a peracetic acid and hydrogen peroxide solution with a polymeric resin functionalized with sulfonic acid to provide a treated peracetic acid and hydrogen peroxide solution.

2. The method according to paragraph 1, wherein the peracetic acid and hydrogen peroxide solution is eluted through a bed of the polymeric resin functionalized with the sulfonic acid to provide the treated peracetic acid and hydrogen peroxide solution.

3. The method according to paragraph 1, wherein the peracetic acid and hydrogen peroxide solution is contacted with an interior portion of a container wall that includes the polymeric resin functionalized with the sulfonic acid.

4. The method according to paragraph 3, wherein the interior portion of the container wall incorporates the polymeric resin functionalized with sulfonic acid via a coating, or is extruded into the material comprising container wall or is embedded into the container wall.

5. The method according to either paragraph 3 or 4, wherein the container comprises a material that is a polypropylene, a polyethylene, a polypropylene and polyethylene copolymer or a polyethylene and polypropylene blend.

6. The method according to any of paragraphs 1 through 5, wherein the polymeric resin functionalized with the sulfonic acid is a divinyl benzene/styrene copolymer, a perfluorosulfonic acid resin or a polymer containing a 2-acrylamido-2-methylpropane sulfonic acid resin.

7. The method according to any of paragraphs 1 through 6, wherein the polymeric resin functionalized with the sulfonic acid is crosslinked.

8. The method according to any of paragraphs 1 through 7, wherein the treated peracetic acid and hydrogen peroxide solution is stable at ambient conditions for at least 180 days, 365 days or 545 days.

9. The method according to paragraph 8, wherein the treated peracetic acid and hydrogen peroxide solution retains at least a 60% concentration of the original concentration of the peracetic acid after at least 180 days, 365 days or 545 days.

10. The method according to paragraph 9, wherein the treated peracetic acid and hydrogen peroxide solution retains at least 80% concentration of the original concentration of the peracetic acid after at least 180 days, 365 days or 545 days.

11. The method according to paragraph 8, wherein the treated peracetic acid and hydrogen peroxide solution retains at least 80% concentration of the original concentration of hydrogen peroxide after at least 180 days, 365 days or 545 days.

12. The method according to paragraph 11, wherein the treated peracetic acid and hydrogen peroxide solution retains at least 90% concentration of the original concentration of hydrogen peroxide after at least 180 days, 365 days or 545 days.

13. A container comprising:

a container wall having an interior surface and an exterior surface, the container wall defining an interstitial space, wherein the container is sealable, wherein the container material that forms the container wall comprises a polymeric resin functionalized with sulfonic acid associated with the interior surface of the container.

14. The container according to paragraph 13, wherein the polymeric resin functionalized with the sulfonic acid is coated onto the interior surface of the container.

15. The container according to paragraph 13, wherein the polymeric resin functionalized with the sulfonic acid is embedded into the interior surface of the container.

16. The container according to paragraph 13, wherein the polymer resin functionalized with the sulfonic acid is extruded into the material that forms the container wall.

17. The container according to any of paragraphs 13 through 16, wherein the container material is a polypropylene, a polyethylene, a polypropylene and polyethylene copolymer or a polyethylene and polypropylene blend.

18. The container according to any of paragraphs 13 through 17, wherein the polymeric resin functionalized with the sulfonic acid is a divinyl benzene/styrene copolymer, a perfluorosulfonic acid resin or a polymer containing a 2-acrylamido-2-methylpropane sulfonic acid resin.

19. The container according to any of paragraphs 13 through 18, wherein the polymeric resin functionalized with the sulfonic acid is crosslinked.

20. The container of according to any of paragraphs 13 through 19, further comprising an outer coating or layer applied to the exterior portion of the container.

21. A packaged solution comprising:

a peracetic acid and hydrogen peroxide solution treated with a polymeric resin functionalized with sulfonic acid to provide a treated peracetic acid and hydrogen peroxide solution; and

a container, wherein the treated peracetic acetic acid and hydrogen peroxide solution is contained.

22. The packaged solution according to paragraph 21, wherein the peracetic acid and hydrogen peroxide solution is eluted through a bed of the polymeric resin functionalized with the sulfonic acid.

23. The packaged solution according to paragraph 21, wherein the peracetic acid and hydrogen peroxide solution is contacted with an interior surface of a container wall that includes the polymeric resin functionalized with the sulfonic acid.

24. The packaged solution according to paragraph 23, wherein the interior surface of the container wall incorporates the polymeric resin functionalize with sulfonic acid via a coating, or is extruded into the material comprising container wall or is embedded into the container wall.

25. The packaged solution according to either paragraph 23 or 24, wherein the container material is a polypropylene, a polyethylene, a polypropylene and polyethylene copolymer or a polyethylene and polypropylene blend.

26. The packaged solution according to any of paragraphs 21 through 25, wherein the polymeric resin functionalized with the sulfonic acid is a divinyl benzene/styrene copolymer, a perfluorosulfonic acid resin or a polymer containing a 2-acrylamido-2-methylpropane sulfonic acid resin.

27. The packaged solution according to any of paragraphs 21 through 26, wherein the polymeric resin functionalized with the sulfonic acid is crosslinked.

28. The packaged solution according to any of paragraphs 21 through 27, wherein the treated peracetic acid and hydrogen peroxide solution is stable at ambient conditions for at least 18 months.

29. The packaged solution according to paragraph 28, wherein the treated peracetic acid and hydrogen peroxide solution retains at least a 60% concentration of the original concentration of the peracetic acid at least 180 days, 365 days or 545 days.

30. The packaged solution according to paragraph 29, wherein the treated peracetic acid and hydrogen peroxide solution retains at least 80% concentration of the original concentration of the peracetic acid at least 180 days, 365 days or 545 days.

31. The packaged solution according to paragraph 28, wherein the treated peracetic acid and hydrogen peroxide solution retains at least 80% concentration of the original concentration of hydrogen peroxide at least 180 days, 365 days or 545 days.

32. The packaged solution according to paragraph 31, wherein the treated peracetic acid and hydrogen peroxide solution retains at least 90% concentration of the original concentration of hydrogen peroxide at least 180 days, 365 days or 545 days.

33. A composition comprising:

hydrogen peroxide;

an organic acid;

a polymeric resin chelator; and

optionally, a surfactant.

34. The composition according to paragraph 33, wherein the composition comprises less than about 1 wt. % of an anticorrosive agent.

35. The composition according to paragraphs 33 or 34, wherein upon application of the composition to a surface, a residue is not deposited upon the treated surface.

36. The composition according to any of paragraphs 33 through 35, wherein the organic acid is peracetic acid.

37. The composition according to paragraph 36, wherein the peracetic acid is formed by the reaction of acetic acid with hydrogen peroxide.

38. The composition according to either of paragraphs 36 or 37, wherein peracetic acid is present in about 1 wt. % to about 15 wt. % of the composition.

39. The composition according to any of paragraphs 36 through 38, wherein the peracetic acid is present in about 3 wt. % to about 10 wt. % of the composition.

40. The composition according to any of paragraphs 36 through 39, wherein peracetic acid is present in about 6.8 wt. % to about 7.5 wt. % of the composition.

41. The composition according to any of paragraphs 33 through 40, wherein the composition is a liquid disinfectant or sterilant.

42. The composition according to any of paragraphs 33 through 41, wherein the composition is non-corrosive.

43. The composition according to any of paragraphs 33 through 42, wherein the composition is non-toxic.

44. The composition according to any of paragraphs 33 through 43, wherein the composition has a long-term stability such that at about 1 atm and about 19° C., less than about 25 wt. % of each component independently degrades over about a year.

45. The composition according to any of paragraphs 33 through 44, wherein the composition has a long-term stability such that at about 1 atm and about 19° C., at least about 80 wt. % of each component is independently present after about one year.

46. The composition according to any of paragraphs 33 through 45, wherein the composition is essentially free of buffer.

47. The composition according to any of paragraphs 33 through 46, wherein the composition comprises less than about 0.1 wt. % buffer.

48. The composition according to any of paragraphs 33 through 47, wherein the hydrogen peroxide is present in about 10 wt. % to about 50 wt. % of the composition.

49. The composition according to any of paragraphs 33 through 48, wherein the hydrogen peroxide is present in at least about 15 wt. % of the composition.

50. The composition according to any of paragraphs 33 through 49, wherein the hydrogen peroxide is present in about 18 wt. % to about 35 wt. % of the composition.

51. The composition according to any of paragraphs 33 through 50, wherein the hydrogen peroxide is present in about 18 wt. % to about 32 wt. % of the composition.

52. The composition according to any of paragraphs 33 through 51, wherein the hydrogen peroxide is present in about 20 wt. % to about 26 wt. % of the composition.

53. The composition according to any of paragraphs 33 through 52, wherein the hydrogen peroxide is present in about 28 wt. % of the composition.

54. The composition according to any of paragraphs 33 through 53, wherein the organic acid comprises acetic acid.

55. The composition according to any of paragraphs 33 through 54, wherein the organic acid comprises glacial acetic acid.

56. The composition according to any of paragraphs 33 through 55, wherein the organic acid comprises acetic acid, present in at least about 3 wt. % of the composition.

57. The composition according to any of paragraphs 33 through 56, wherein the organic acid comprises acetic acid, present in about 3 wt. % to 65 wt. % of the composition.

58. The composition according to any of paragraphs 33 through 57, wherein the organic acid comprises acetic acid, present in about 7 wt. % to about 14 wt. % of the composition.

59. The composition according to any of paragraphs 33 through 58, wherein the organic acid comprises acetic acid, present in about 9 wt. % to about 11 wt. % of the composition.

60. The composition according to any of paragraphs 33 through 59, wherein the organic acid comprises acetic acid, present in about 10 wt. % to about 22 wt. % of the composition.

61. The composition according to any of paragraphs 33 through 60, wherein the organic acid comprises acetic acid, present in about 16 wt. % of the composition.

62. The composition according to any of paragraphs 33 through 61, wherein the polymeric resin chelator effectively chelates transition metals.

63. The composition according to any of paragraphs 33 through 62, wherein the polymeric resin chelator comprises a sulfonic acid functionalized polymer.

64. The composition according to any of paragraphs 33 through 62, wherein the polymeric resin chelator comprising a polymeric resin functionalized with the sulfonic acid is a divinyl benzene/styrene copolymer, a perfluorosulfonic acid resin or a polymer containing a 2-acrylamido-2-methylpropane sulfonic acid resin.

65. The composition according to any of paragraphs 33 through 64, wherein the polymeric resin chelator is present in about 0.1 wt. % to about 5 wt. %.

66. The composition according to any of paragraphs 33 through 65, wherein the polymeric resin chelator is present in about 0.2 wt. % to about 2 wt. %.

67. The composition according to any of paragraphs 33 through 66, wherein the polymeric resin chelator is present in about 0.5 wt. % to about 1.5 wt. %.

68. The composition according to any of paragraphs 33 through 67, wherein the surfactant comprises a non-ionic surfactant.

69. The composition according to any of paragraphs 33 through 68, wherein the surfactant comprises at least one of an anionic and cationic surfactant.

70. The composition according to any of paragraphs 33 through 69, wherein the anionic surfactant comprises a polyoxypropylene-polyoxyethylene block copolymer.

71. The composition according to paragraph 70, wherein the polyoxypropylene-polyoxyethylene block copolymer comprises at least about 0.1 wt. % of the composition.

72. The composition according to paragraphs 70 or 71, wherein the polyoxypropylene-polyoxyethylene block copolymer is present in about 0.1 wt. % to about 8 wt. % of the composition.

73. The composition according to any of paragraphs 70 through 72, wherein the polyoxypropylene-polyoxyethylene block copolymer is present in about 1 wt. % to about 3 wt. % of the composition.

74. The composition according to any of paragraphs 70 through 73, wherein the polyoxypropylene-polyoxyethylene block copolymer is present in about 2 wt. % of the composition.

75. The composition according to any of paragraphs 33 through 74, wherein the hydrogen peroxide is present in a concentration of about 0.5 wt. % to about 30 wt. % the organic acid is acetic acid, present in a concentration of about 1 wt. % to about 25 wt. %; the polymeric resin chelator is a sulfonic acid functionalized polymer, present in a concentration of about 0.1 wt. % to about 5 wt. %; and the surfactant, if present, is a polyoxypropylene-polyoxyethylene block copolymer, present in a concentration of about 1 wt. % to about 2.0 wt. %; wherein the composition further comprises about 50 wt. % deionized water.

76. The composition according to any of paragraphs 33 through 74, wherein the hydrogen peroxide is present in a concentration of about 20-26 wt. %; the organic acid is acetic acid, present in a concentration of about 9.0 to 11.0 wt. %; the polymeric resin chelator is a sulfonic acid functionalized polymer present in a concentration of about 0.1 wt. % to about 5 wt. %; and the surfactant is a polyoxypropylene-polyoxyethylene block copolymer, if present, in a concentration of about 1 wt. % to about 2.0 wt. %; wherein the composition further comprises about 50 wt. % deionized water; and wherein the composition further comprises about 5 wt. % to 8 wt. % peracetic acetic acid.

77. The composition according to any of paragraphs 33 through 76, wherein the balance of the composition is water.

78. The composition according to any of paragraphs 33 through 77, wherein the balance of the composition is deionized water.

79. The composition according to any of paragraphs 33 through 78, which is a liquid concentrate disinfectant or sterilant.

80. The composition according to any of paragraphs 33 through 74, formulated for use in a sprayable composition.

81. The composition according to any of paragraphs 33 through 80, formulated for use in contacting a surface of at least one of a hospital, physician's office, medical clinic, medical facility, dental office, dental facility, airport, school, pet store, zoo, children's day care, elderly nursing home, museum, movie theatre, athletic facility, sporting arena, gymnasium, rest room, bathroom, shopping center, amusement park, church, synagogue, mosque, temple, restaurant, food processing facility, food manufacturing facility, pharmaceutical company, hot-tub, sauna, and clean room.

82. The composition according to any of paragraphs 33 through 80, formulated for use in contacting at least one of metal, plastic, natural rubber, synthetic rubber, glass, stone, grout, fiberglass, wood, concrete, construction product, and building product.

83. The composition according to any of paragraphs 33 through 80, formulated for use in contacting at least one of medical equipment, medical device, surface in the medical industry, dental equipment, dental device, and surface in the dental industry.

84. The composition according to any of paragraphs 33 through 78, comprising a one part, liquid concentrate disinfectant or sterilant, wherein: the hydrogen peroxide concentration is about 20.0 wt. % to about 26.0 wt. %; the acetic acid concentration is about 9.0 wt. % to about 11.0 wt. %; the polymeric resin chelator is a sulfonic acid functionalized polymer present in a concentration of about 0.1 wt. % to about 5 wt. %; and the surfactant is a polyoxypropylene-polyoxyethylene block copolymer, present in a concentration of about 1 wt. % to about 2.0 wt. %; and the peracetic acid concentration is about 5.0 to about 8 wt. %.

85. A kit comprising: an enclosed container comprising a removable closure, the composition of any of paragraphs 33 through 84, located inside an enclosed container, and printed indicia located on the enclosed container.

86. The kit according to paragraph 85, wherein the enclosed container is manufactured from high density polyethylene (HDPE).

87. The kit according to paragraphs 85 or 86, wherein the enclosed container is opaque.

88. The kit according to any of the paragraphs 85 through 87, wherein the printed indicia comprises instructions to avoid excessive heat, to avoid elevated temperatures, to avoid direct sunlight, or combinations thereof.

89. The kit according to any of the paragraphs 85 through 88, wherein the enclosed container further comprises a head space.

90. The kit according to any of the paragraphs 85 through 89, wherein the enclosed container further comprises a head space, wherein the head space comprises oxygen (02), peracetic acid vapor and/or acetic acid vapor.

91. The kit according to any of the paragraphs 85 through 90, wherein the enclosed container further comprises a head space, present in up to about 1% to about 25% (v/v) of the enclosed container.

92. The kit according to any of the paragraphs 85 through 91, wherein a removable closure of the enclosed container comprises a pressure valve, configured to release excessive gas from within the enclosed container.

93. The kit according to any of the paragraphs 85 through 92, further comprising a liquid applicator comprising at least one of a spray bottle, wipe, cloth, sponge, non-woven fabric, and woven fabric.

94. A method for reducing the number of microbes located upon a substrate, the method comprising the step of contacting the substrate with an effective amount of the composition of any one of paragraphs 33 through 80, for a sufficient period of time, effective to reduce the number of microbes located upon the substrate.

95. The method according to paragraph 94, wherein the microbe or microorganism includes at least one of a virus, fungus, mold, slime mold, algae, yeast, mushroom and bacterium.

96. The method according to paragraph 94 or 95, wherein up to about 4 logs of the microbe or microorganism is inactivated in about 30 minutes or less (e.g., 15 minutes, 10 minutes, 5 minutes, 3 minutes or 1 minute) or up to about 12 logs of the microbe or microorganism is inactivated in about 60 minutes or less (e.g., 30 minutes, 15, minutes, 10 minutes, 5 minutes, 3 minutes or 1 minute).

97. A method of killing or inhibiting a microorganism, the method comprising the step of contacting the microorganism with an antimicrobially effective amount of the composition of any of paragraphs 33 through 80, for a sufficient period of time, effective to kill or inhibit the microorganism.

98. A method of disinfecting or sterilizing a substrate, the method comprising the step of contacting the substrate with an effective amount of the composition of any of paragraphs 33 through 80, for a sufficient period of time, effective to disinfect or sterilize the substrate.

99. The method of any of paragraphs 94 through 98, wherein the substrate to be contacted is a medical device.

100. The method of any of paragraphs 94 through 98, wherein the substrate to be contacted is a soiled endoscopic device.

101. The method of any of paragraphs 94 through 98, wherein the substrate to be contacted is cleaned prior to disinfecting or sterilization.

102. The method of any of paragraphs 94 through 98, wherein the substrate to be contacted is a medical device, wherein the medical device is cleaned to remove foreign and fecal matter prior to disinfecting or sterilization.

103. The method of any of paragraphs 94 through 98, wherein the substrate to be contacted is an endoscopic device, wherein the endoscopic device is cleaned to remove foreign and fecal matter prior to disinfecting or sterilization.

104. The method of any of paragraphs 94 through 98, wherein the substrate to be contacted is a cleaned medical device.

105. The method of any of paragraphs 94 through 98, wherein the substrate to be contacted is a cleaned endoscopic device.

106. The composition or method of any of paragraphs 1 through 105, wherein the composition and/or the container does not include any 1-hydroxyethylidene-1,1,-diphosphonic acid.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

### Example 1

The scope of the experiment was to compare the efficacy of Aquivion E87-05S sheet in stabilizing PAA chemistry in comparison to the stabilizer (Dequest). The goal of the experiment was to determine the efficacy of Aquivion E87-05S sheets in stabilizing PAA chemistry in the presence of a cation contaminate. The cation contaminate was found from previous experiences to facilitate the degradation of hydrogen peroxide and peroxyacetic acid component in Rapicide PA and REVOX PA chemistry. The cation can oxidize/react with hydrogen peroxide and peroxyacetic acid in PAA chemistry thus facilitating the degradation of the product. Dequest works as a stabilizer component by chelating the cation which prevents it from oxidizing/reacting with the hydrogen peroxide and peroxyacetic acid.

Aquivion E87-05S is a polymer that is not dissolvable in PAA chemistry (due to the Teflon like backbone of the polymer structure) but due to the sulfate group in the polymer chain, it can bind with cation and thus prevent the oxidization/reaction of the cation with the oxidizer in PAA chemistry. For the purpose of the study, iron sulfate was used as the cation contaminate. In solution, iron sulfate dissociates into iron cation (Fe²⁺) which has been found to cause degradation of hydrogen peroxide and peroxyacetic acid.

The polymeric resin chelator was used as is without any conditioning prior to use.

### Definitions

DI: Deionized (water)

H₂O₂: Hydrogen peroxide

PAA: Peroxyacetic acid

AA: Acetic acid

PPM: Parts per million

FeSO₄: Iron sulfate

CaCl₂: Calcium chloride

Sample Size

For the purpose of the study, two samples of each condition were used (control and samples) and tested. The sample volume used for the study was 1 Liter total to simulate the bottle size of the REVOX PA.

TEST Procedure

Materials And Apparatus

All materials and equipment for titration of hydrogen peroxide and peroxyacetic acid by the method described below.

50% hydrogen peroxide

Glacial acetic acid

DI (deionized water)

Analytical Balance

1 L bottles (HDPE)

pH Meter

Iron sulfate

Calcium chloride

Dequest

Aquivion® E87-05S sheets

Titration method

Materials and Reagent:

Apparatus:

Analytical Balance capable to measure accurately down to 0.1 mg.

Automatic Dispenser Burettes

Erlenmeyer flask, 250 mL

100 μL micropipetter and tips

Disposable Pipettes

Reagents:

Potassium Permanganate (KMnO₄), 0.05N standardized, certified, Ricca Chemical, Cat. No. 6390-1

Sodium Thiosulfate (Na₂S₂O₃), 0.01N standardized, certified, Ricca Chemical, Cat. No. 7890-1

Potassium Iodide (KI), 1% (W/V) Aqueous Solution with DI water. Made from Potassium Iodide Crystal, Alfa Aesar, Cat. No. 11601

Starch Indicator, Fisher, Cat. No. SS408-4

Sulfuric Acid, 25% v/v Aqueous Solution with DI water. Made from Sulfuric Acid Concentrate, Fisher Scientific, Cat. No. A298-212

Procedure:

Blank Titration:

In a 250 mL Erlenmeyer flask, rinse the flask wall with 10-20 mL DI water.

Add 20 mL of 25% v/v sulfuric acid.

From the burette, add ONE Drop of 0.05N potassium permanganate into the blank solution. (Pale pink color observed, which persists for at least 10 seconds.)

To the pale pink solution, add 20 mL of 1% w/v potassium iodide solution. Color change from pale pink to pale yellow.

Pipette 1 mL of starch indicator solution into the same flask. Color change from pale yellow to blue/purple color.

Immediately titrate with 0.01N sodium thiosulfate to colorless, water-clear endpoint which persists for at least 10 seconds.

Record the volume (mL) of sodium thiosulfate used to reach the endpoint. This will be subtracted as background in peracetic acid determination.

This volume is the (mL of Na₂S₂O₃)_{Blank}

Sample Titration:

Into a tared 250 mL Erlenmeyer flask, weight a specified mass of product sample and record the weight to 0.0001 g with the analytical balance. This is the mass of the sample.

For 4-6% PAA samples, sample size of 0.1 g is used.

For 0.06-0.1% PAA samples, sample size of 3-4 g is used.

Rinse the flask wall with 10-20 mL DI water.

Add 20 mL of 25% v/v sulfuric acid.

Titrate with 0.05N potassium permanganate until then endpoint reach. The endpoint is when the last drop generate a pale pink color that persist for at least 10 seconds.

Record the volume used of 0.05N potassium permanganate for the titration. This volume will be used to calculate the weight percent of hydrogen peroxide in the sample.

This volume is the (mL of KMnO₄)ₛₐₘₚₗₑ

To the pale pink solution, add 20 mL of 1% w/v potassium iodide solution. Color change from pale pink to yellow color.

Immediately titrate with 0.01N sodium thiosulfate to a pale yellow color.

Pipette 1 mL of starch indicator solution into the same flask. Color change from pale yellow to blue/purple color.

Continue the titration with 0.01N sodium thiosulfate to colorless, water-clear endpoint which persists for at least 10 seconds.

Record the volume (mL) of sodium thiosulfate used to reach the endpoint. This will be used to calculate the weight percent peracetic acid in the sample.

This volume is the (mL of Na₂S₂O₃)ₛₐₘₚₗₑ

Calculation:

Concentration of each analyte is calculated as shown below.

Hydrogen Peroxide Concentration:

$$\% {H}_{2} {O}_{2} = \frac{{( mL of {KMnO}_{4} )}_{Sample} * ( N of {KMnO}_{4} ) * 17.01 * 100}{( Mass of sample ( g ) ) * 1000}$$

Where N is the normality of potassium permanganate used. (N of KMnO₄)=0.05

Peracetic Acid Concentration:

$$\% PAA = \frac{\begin{matrix}[ {( mL of {Na}_{2} {S}_{2} {O}_{3} )}_{Sample} - {( mL of {Na}_{2} {S}_{2} {O}_{3} )}_{Blank} ] * \\ ( N of {Na}_{2} {S}_{2} {O}_{3} ) * 38.025 * 100\end{matrix}}{( Mass of sample ( g ) ) * 1000}$$

Where N is the normality of sodium thiosulfate used. (N of Na₂S₂O₃)=0.01

Experimental Procedure

Preparation of Dequest Free PAA Chemistry Stock Solution (ID: No Dequest PAA Stock

To a 5 L container, 3420 g of 50% hydrogen peroxide and 700 g of glacial acetic acid were added. The actual mass was adjusted to compensate for the actual concentration of hydrogen peroxide and acetic acid.

The solution was mixed and stored at room temperature (22-25° C.) for 8 days for PAA generation.

After 8 days, the mixture was titrated for hydrogen peroxide and PAA concentration. When the PAA concentration was 7.0% or greater, the generation process achieved completion. If the PAA concentration was lower than 7.0%, the sample was allowed to react for a longer period of time until the target concentration was reached.

When the target PAA concentration was achieved, DI water was added to dilute the mixture to final target concentration of 22-26% hydrogen peroxide and 5-5.5% PAA and 9-11% Acetic acid. The amount of DI water needed to be add depended on the concentration of PAA observed in the mixture based on titration. 50% hydrogen peroxide and glacial acetic acid can be used to adjust the concentration to the target value if needed.

Sample preparation for testing:

Negative Control Samples: The negative control sample contained no stabilizer. The No Dequest PAA Stock was used as is for testing to observe the rate of degradation due to cation contaminate.

Positive Control Sample: The positive control samples contained 1% Dequest stabilizer and 0.1% Dequest stabilizer. These samples simulate the current Rapicide PA Part A and REVOX PA chemistry as well as a sample of PAA chemistry with a lower concentration of Dequest stabilizer. From historical data, with Dequest stabilizer, the products were able to achieve 18M stability at normal storage conditions at 1% Dequest concentration. Also, previous experiments have found that at 0.1% concentration of Dequest, the stabilizer can still generate sufficient stability in the PAA chemistry.

Test Samples: The test samples for the study had variations of concentration (mass to volume) of Aquivion sheets added to the chemistry. The following concentrations were used for the testing.

Sample #1: 15.5 cm×31 cm sheet

Sample #2: 18 cm×18 cm sheet

Sample #3: 18 cm×9 cm sheet

Note: All sample sheet had the mass recorded before use.

Justification: For the purpose of the study, the samples simulated the concentration of chelator/ion exchange based on the mole concentration in comparison to 0.1% Dequest concentration. At 0.1% Dequest, there are 0.06% HEDP. For a 1 L sample, it is 0.6 g of HEDP (equiv. to 0.0029 mole of HEDP M.W. 206.03 g/mol). For the Aquivion E87-205 sheet, the M.W. is 870 g/mol. With a sheet of 31 cm×31 cm and 50 μm thickness, the mass of the sheet was 11.29 g. To match 0.0029 mole of chelator/ion exchange, the mass of the Aquivion E87 sheet needed was 2.53 g which is approximately ¼ the size of a sheet of 31 cm×31 cm. For simplicity of testing, Samples 1, 2 and 3 had approximately ½, ¼, and ⅛ the size of a 31 cm×31 cm sheet. The actual mass of the Aquivion sheet used was recorded to determine the actual number of mole used for the study.

Note All samples and controls had a total volume of 1 liter.

Spiking of cation contaminate:

For the testing, a 5% w/v of iron sulfate was used as a stock for spiking process. This stock was made by dissolving 5 g of iron sulfate to a total volume of 100 mL with DI water.

To each control and sample, 1 mL of 5% iron sulfate was added to 999 mL of control/sample. This generated a final concentration of approximately 50 ppm of iron sulfate in solution

Analysis:

For all controls and samples, hydrogen peroxide and peroxyacetic acid concentrations were determined by titration.

All samples were titrated at least once a week and the changes in the concentration of hydrogen peroxide and peracetic acid were monitored.

The concentration of hydrogen peroxide and peroxyacetic acid of all samples and controls versus time were plotted.

Data Analysis

All samples were titrated for hydrogen peroxide and peroxyacetic acid concentration during the defined time interval of the study.

Acceptance Criteria

The test samples required similar PAA and hydrogen peroxide stability in comparison to the Positive control samples (1% Dequest Samples).

TABLE 1
Sample preparation information and ID.
Sample Description

| | | | | mmol of |
|---|---|---|---|---|
| | | Mass of | Surface Area of | Stabilizer |
| | | Stabilizer | Sheet per Liter of | per Liter of |
| Sample # | Stabilizer | (g) | Chemistry(cm²) | Chemistry |
| 1 | Control | 0 | N/A | N/A |
| 2 | Control | 0 | N/A | N/A |
| 3 | 1% Dequest | 10.1061 | N/A | 49.05 |
| 4 | 1% Dequest | 10.0219 | N/A | 48.64 |
| 5 | 0.1% | 1.0825 | N/A | 5.25 |
| | Dequest | | | |
| 6 | 0.1% | 1.0459 | N/A | 5.08 |
| | Dequest | | | |
| 7 | ½ Sheet | 5.6674 | 961.0 | 6.51 |
| 8 | ½ Sheet | 5.6313 | 961.0 | 6.47 |
| 9 | ¼ Sheet | 3.7759 | 648.0 | 4.34 |
| 10 | ¼ Sheet | 3.8094 | 648.0 | 4.38 |
| 11 | ⅛ Sheet | 2.0109 | 324.0 | 2.31 |
| 12 | ⅛ Sheet | 1.8041 | 324.0 | 2.07 |

TABLE 2
Hydrogen Peroxide stability data for No Dequest PAA Study with Aquivion Sheet and Iron Sulfate spike.

| | | | #3: | #4: | #5: | #6: | #7: | #8: | #9: | #10: | #11: | #12: |
|---|---|---|---|---|---|---|---|---|---|---|---|---|
| | #1: | #2: | 1% | 1% | 0.1% | 0.1% | ½ | ½ | ¼ | ¼ | ⅛ | ⅛ |
| # of | Control | Control | Dequest | Dequest | Dequest | Dequest | Sheet | Sheet | Sheet | Sheet | Sheet | Sheet |
| Day | % H2O2 | % H2O2 | % H2O2 | % H2O2 | % H2O2 | % H2O2 | % H2O2 | % H2O2 | % H2O2 | % H2O2 | % H2O2 | % H2O2 |
| 0 | 24.1132 | 23.9020 | 24.0076 | 24.0076 | 24.0076 | 24.0076 | 24.0076 | 24.0076 | 24.0076 | 24.0076 | 24.0076 | 24.0076 |
| 1 | 24.0618 | 24.0171 | 24.1110 | 23.9118 | 24.5469 | 23.9986 | 23.9921 | 24.1541 | 24.0722 | 24.2409 | 24.1196 | 24.2383 |
| 6 | 23.6787 | 23.6949 | 23.4595 | 23.5146 | 23.7359 | 23.6510 | 23.6096 | 23.5878 | 23.6717 | 23.7914 | 23.7869 | 23.8116 |
| 9 | 25.0880 | 25.3541 | 25.2130 | 25.1798 | 25.3494 | 25.5470 | 25.6237 | 25.7768 | 25.6631 | 25.8778 | 25.4830 | 25.6023 |
| 14 | 25.1329 | 24.9777 | 24.9338 | 24.8210 | 24.9297 | 24.9502 | 25.1676 | 25.2836 | 25.2754 | 25.2403 | 25.2051 | 25.2909 |
| 20 | 24.6108 | 24.6397 | 24.9637 | 25.0188 | 24.8347 | 24.8406 | 25.4183 | 25.2990 | 25.3003 | 25.4570 | 25.5217 | 25.4212 |
| 27 | 23.6688 | 23.7535 | 24.8186 | 24.8194 | 24.7413 | 24.6413 | 25.3024 | 25.2898 | 25.2237 | 25.3072 | 25.3376 | 25.3607 |
| 34 | 21.8615 | 22.1983 | 24.6331 | 24.7121 | 24.5658 | 24.4215 | 25.3733 | 25.3912 | 25.4232 | 25.3012 | 25.5080 | 25.2934 |

TABLE 3
Peracetic acid stability data for PAA Study with Aquivion Sheet and Iron Sulfate spike. The data showed
that after 27 days, the control samples were below the End of Shelf Life criteria for PAA concentration.
At 34 days, the Aquivion samples with ¼ sheet were equivalent to the 1% Dequest samples.

| | | | #3: | #4: | #5: | #6: | #7: | #8: | #9: | #10: | #11: | #12: | End of |
|---|---|---|---|---|---|---|---|---|---|---|---|---|---|
| | #1: | #2: | 1% | 1% | 0.1% | 0.1% | ½ | ½ | ¼ | ¼ | ⅛ | ⅛ | Shelf |
| # of | Control | Control | Dequest | Dequest | Dequest | Dequest | Sheet | Sheet | Sheet | Sheet | Sheet | Sheet | Life |
| Day | % PAA | % PAA | % PAA | % PAA | % PAA | % PAA | % PAA | % PAA | % PAA | % PAA | % PAA | % PAA | % PAA |
| 0 | 5.4500 | 5.4571 | 5.4536 | 5.4536 | 5.4536 | 5.4536 | 5.4536 | 5.4536 | 5.4536 | 5.4536 | 5.4536 | 5.4536 | 4.426 |
| 1 | 5.4948 | 5.4362 | 5.5309 | 5.4749 | 5.4283 | 5.5073 | 5.4871 | 5.5308 | 5.5168 | 5.5237 | 5.4822 | 5.4526 | 4.426 |
| 6 | 5.5265 | 5.5200 | 5.6999 | 5.9015 | 5.6611 | 5.6484 | 5.8119 | 5.7949 | 5.7056 | 5.7666 | 5.7112 | 5.6873 | 4.426 |
| 9 | 5.3962 | 5.3747 | 5.7775 | 5.9586 | 5.6195 | 5.6594 | 5.9178 | 5.8830 | 5.9279 | 5.8780 | 5.8162 | 5.8245 | 4.426 |
| 14 | 5.3948 | 5.2762 | 5.8054 | 5.8321 | 5.6610 | 5.5826 | 5.8943 | 5.9105 | 5.8954 | 5.8749 | 5.8947 | 5.8336 | 4.426 |
| 20 | 5.0284 | 5.0554 | 5.8420 | 5.9234 | 5.6218 | 5.5855 | 5.9859 | 5.9371 | 5.9495 | 5.8865 | 6.0066 | 5.9200 | 4.426 |
| 27 | 4.0643 | 4.3196 | 5.8333 | 5.8428 | 5.4995 | 5.4640 | 5.9307 | 5.9838 | 5.9269 | 5.9412 | 5.8601 | 5.8789 | 4.426 |
| 34 | 2.5759 | 2.7970 | 5.6550 | 5.6220 | 5.2214 | 5.1879 | 5.7852 | 5.6690 | 5.6760 | 5.6222 | 5.5672 | 5.4797 | 4.426 |

Conclusions

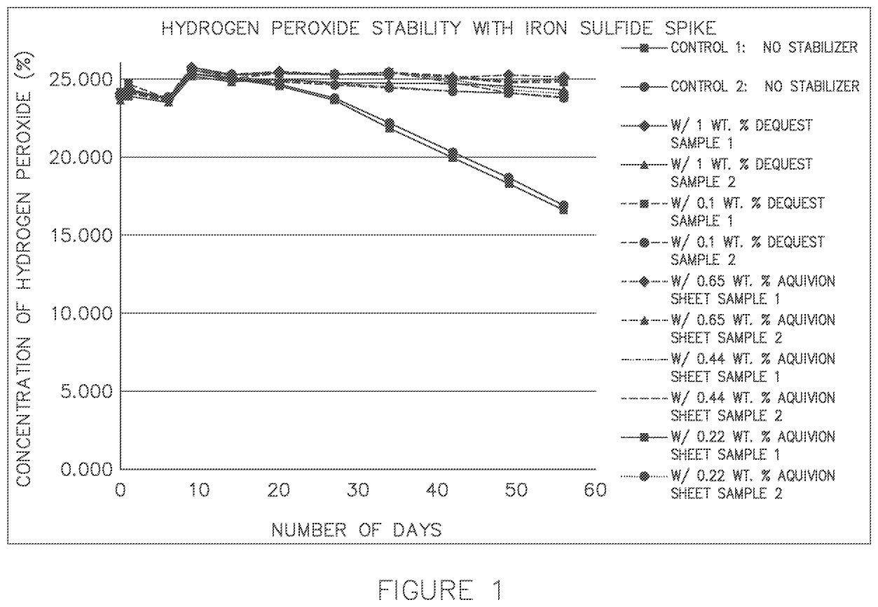

FIG. 1 details a hydrogen peroxide stability study for PAA chemistry with different stabilizers and spiked with iron sulfate.

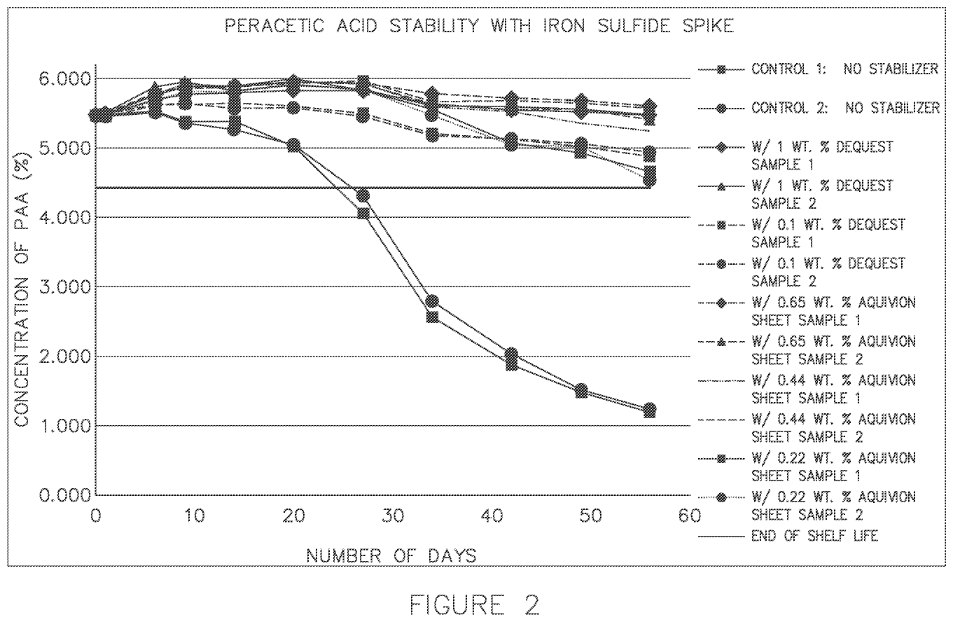

FIG. 2 provides a peroxyacetic acid stability study for PAA chemistry with different stabilizers and spiked with iron sulfate. The results showed that after 27 days, the control samples dropped below the current End of Shelf Life defined for Rapicide PA Part A. The data also showed that at 0.1% Dequest, slight decrease of the PAA concentration was observed, which indicated that the 0.1% Dequest was not sufficient to control the iron sulfate contaminate. After 34 days, all sample have dropped in PAA concentration. From comparison of PAA concentration it was observed that the samples with ½ sheet of Aquivion sheet were still maintaining a higher PAA concentration than the 1% Dequest sample. The ⅛ sheet of Aquivion sheet samples were having PAA concentrations below the 1% Dequest samples. The data indicated that at ¼ sheet, it would have approximately equivalent efficacy as that of the 1% Dequest sample. Sample numbers correspond to the sample numbers found in Table 1.

The results showed that the Aquivion sheet tested controlled the stability of hydrogen peroxide and peracetic acid in the presence of iron contaminate. The data after 27 days showed that it was equivalent to 1.0% Dequest concentration of stabilizer for Rapicide PA Part A, Revox PA and Renalin. At 34 days, the data showed that a ¼ sheet sample of Aquivion stabilizer were able to match the efficacy as that of the 1% Dequest sample with PAA concentration stability equivalent to the 1% Dequest sample #3 and #4.

### Example 2

The purpose the studies described below was to develop a new method for stabilizing various PAA chemistry formulations (which include four main components: hydrogen peroxide (H₂O₂), acetic acid (AA), peracetic acid (PAA) and water) with ion exchange polymer (resin). The goal of the studies was to find a replacement for the current stabilizer (Dequest) currently used in PAA chemistry product (Renalin, Minncare, Rapicide PA Part A, REVOX PA, Actril, etc.) to stabilize the main active ingredients: hydrogen peroxide and peracetic acid. With new sterilization technology utilizing PAA chemistry as well as more presence of PAA chemistry used in clinic and hospital as a high level disinfection for surfaces and medical equipment, the demand for a chemistry that does not leave a residue has developed for PAA chemistry. Dequest (a stabilizer commonly found in PAA chemistry) has become less ideal for used in PAA chemistry due to the deposit/residue that the component leaves behind after use. Dequest's main component is 1-Hydroxyl ethylidene-1,1-diphosphonic acid (HEDP) which in pure form is a solid at room conditions which contributes to the majority of the residue found in current PAA chemistry products. It is believed that HEDP functions as a stabilizer by chelating various free ion contaminates commonly found in PAA chemistry products (e.g., iron, magnesium, calcium, etc.) which can degrade hydrogen peroxide and peracetic acid. The studies below analyze the use of an alternative method (ion exchange resin/polymer) for removal of the free ion contaminate(s) to stabilize PAA chemistry formulation. The ion exchange resin/polymer does not dissolve in PAA chemistry solution which is ideal to use as a stabilizer for the PAA chemistry without residue after use.

Experiment #1: Amberlite Resin Rinse for No Dequest PAA Chemistry.

Materials:

Bottle Wash:

Study #1: Lot 739865

Study #2: Lot 754060 and 749365

Bottle wash is a product with similar concentrations of hydrogen peroxide, acetic acid and peracetic acid to Medivators current products: Rapicide PA Part A, Renalin, Minncare, and REVOX PA without inclusion of Dequest.

Bottle wash was made to meet the criteria of the products described without Dequest (stabilizer) added to the formulation. Due to the absence of Dequest, the product does not have the stability needed for use to replace the other PAA chemistry products.

Amberlite Na⁺ 120 (ion exchange resin/polymer)

0.5N Hydrochloric acid (used for the conditioning the ion exchange resin)

Column for use to hold the resin during rinsing of the bottle was a 60 mL syringe

50% hydrogen peroxide

Glacial acetic acid

DI Water (deionized water)

Analytical Balance

All materials confirmed by PAA and hydrogen peroxide titration method described herein.

Procedure:

Ion exchange resin column: A 60 mL syringe with glass wool at the both ends of the column was filled with 40 gram of Amberlite Na⁺ 120.

Ion exchange resin column conditioning:

300 mL of 0.5N hydrochloric acid was passed through the column (by gravity) to condition the column.

After the hydrochloric acid was drained, 1000 mL of DI water (gravity drain) was passed through the column to remove any remaining hydrochloric acid residual.

Then the column was rinsed with 300 mL of bottle wash solution (same lot with the test solution bottle to remove residual DI water in the column). This step was done to prevent dilution of Bottle wash solution due to the presence of residual water in the column.

Study #1 and 2: High Level PAA Samples (5% PAA)

Bottle wash was used directly as the testing solution.

Rinsing and Filling procedure:

Bottles (HDPE) used for the testing were pre-rinsed with DI water at least four (4) times and air dried before use.

Bottle wash solution was passed through the ion-exchange column and allowed to drain directly into the pre-cleaned bottle for testing.

By rinsing the bottle wash solution through the ion exchange resin column, any free-ion (iron, magnesium, calcium, etc.) would be removed by adhering to the resin and only PAA chemistry would be allowed to flow through the column which allow the chemistry to be more stable during storage.

For testing, a control sample of bottle wash (not processed with any ion exchange resin) was used to compare with the test samples (rinsed with Amberlite Na 120 resin).

Study #3: Low Level PAA Samples (0.06% PAA)

Sample Prep: Actril without Dequest.

Dilute the bottle wash solution using DI water, glacial acetic acid and 50% hydrogen peroxide to match the concentration of Actril product.

Rinsing and Filling procedure:

Bottles (HDPE) used for the testing were pre-rinsed with DI water at least four (4) times and air dried before use.

Actril solution without Dequest was passed through the ion-exchange column and allowed to drain directly into the pre-cleaned bottle for testing.

By rinsing the test solution through the ion exchange resin column, any free-ion (iron, magnesium, calcium, etc.) would be removed by adhering to the resin and only PAA chemistry are allow to flow through the column which allow the chemistry to be more stable during storage.

For testing, a control sample of the test solution (not processed with any ion exchange resin) was used to compare with the test samples (rinsed with Amberlite Na 120 resin).

For all studies, hydrogen peroxide and peracetic acid concentrations were determined by titration as described herein. Samples were stored at room temperature in the dark in a cabinet.

Results:

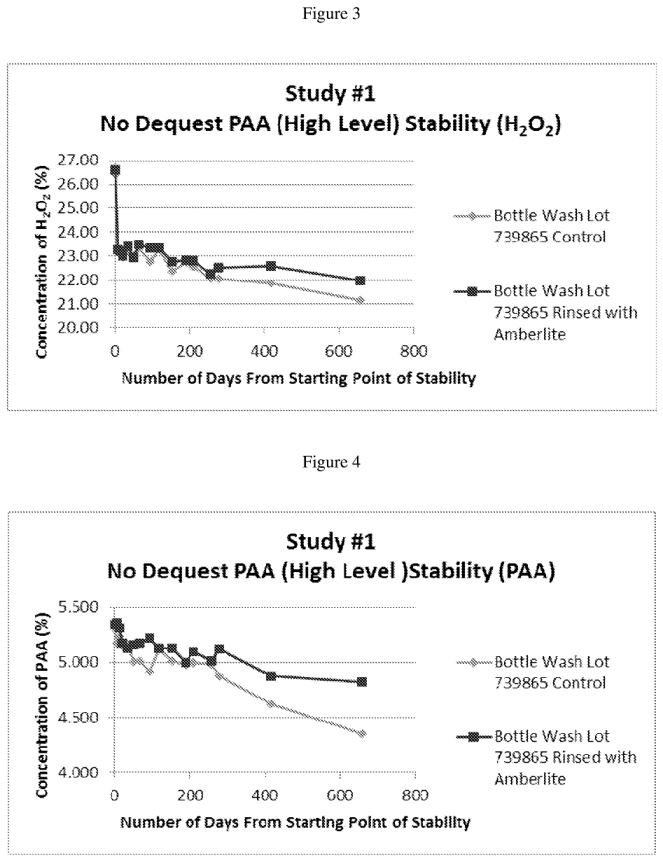

Study #1: FIG. 3 provides data demonstrating that with an Amberlite rinse, the bottle wash chemistry has a higher hydrogen peroxide concentration after 658 days than that of the bottle wash chemistry without the Amberlite rinse (the control).

Study #1: FIG. 4 provides stability data of peracetic acid for PAA chemistry without Dequest as a stabilizer. The data showed that with an Amberlite rinse, the sample still contains a PAA concentration higher the required end of shelf life concentration of 4.426% PAA with the current Rapicide PA Part A chemistry after 658 days. Without the Amberlite rinse (control sample), the product dropped below the required concentration of PAA for the product to be efficacious.

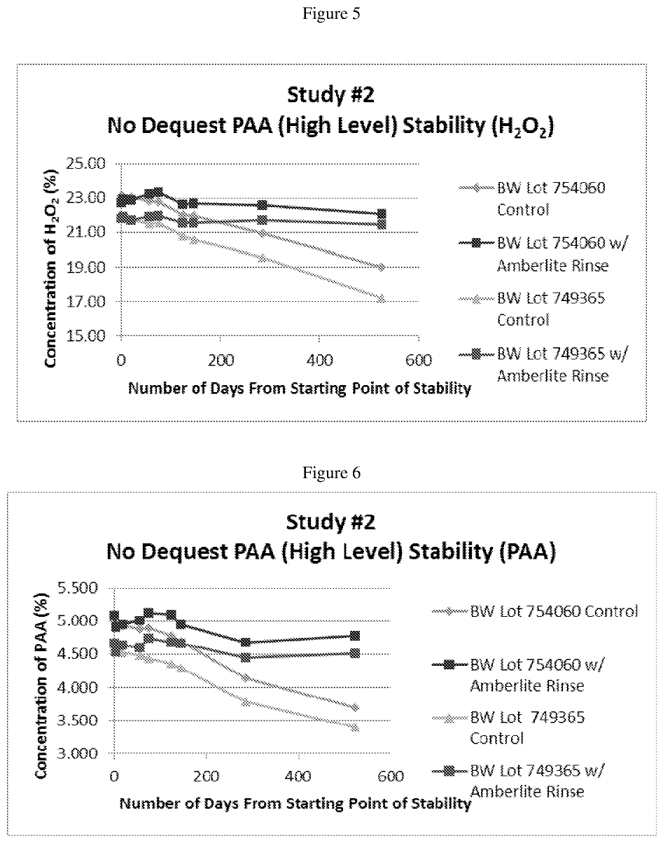

Study #2: FIG. 5 provides stability data of hydrogen peroxide for PAA chemistry without Dequest with two different lots of bottle wash. The data showed that with an Amberlite rinse, both lots of bottle wash chemistries were found to retain a higher concentration of hydrogen peroxide at the end of the study as compared to the control samples.

Study #2: FIG. 6 provides stability data of peracetic acid for PAA chemistry without Dequest with two different lots of bottle wash. The data showed that with an Amberlite rinse, the both lots of bottle wash still contain a PAA concentration higher the required end of shelf life concentration of 4.426% PAA with the current Rapicide PA Part A chemistry after 524 days. Without the Amberlite rinse (control samples), both lots of bottle wash dropped below the required concentration of PAA for the product to be efficacious.

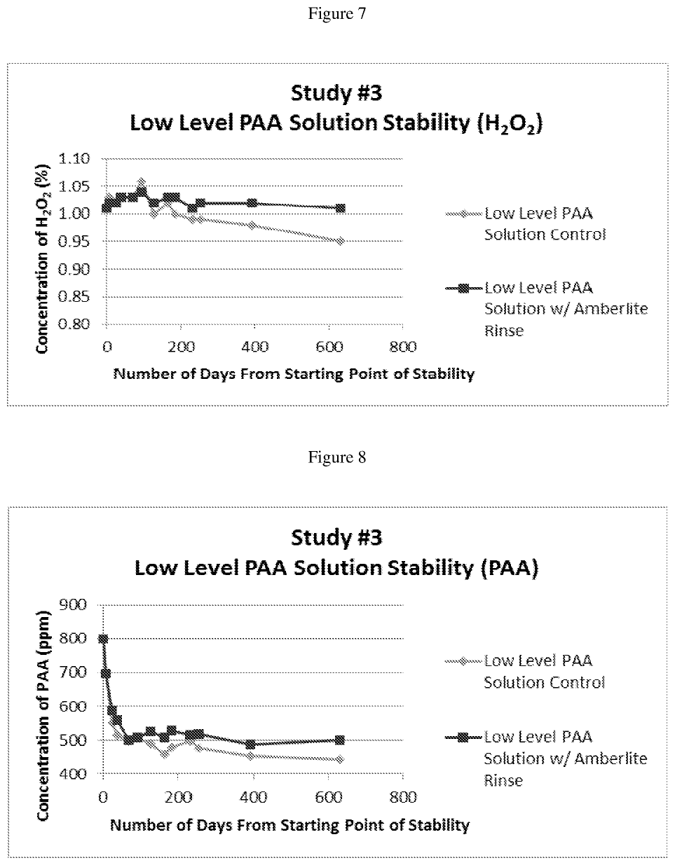

Study #3: FIG. 7 provides stability data of hydrogen peroxide for PAA chemistry without Dequest. The data showed that with an Amberlite rinse, the bottle wash chemistry has a higher hydrogen peroxide concentration after 631 days that samples without the wash (control samples).

Study #3: FIG. 8 provides stability data of peracetic acid for PAA chemistry without Dequest. The data showed that with an Amberlite rinse, the sample contains a PAA concentration higher than the control sample.

Conclusions: The use of Amberlite Na 120 resin to remove free ions from the bottle wash and low level PAA solution chemistry (example of high and low level of PAA chemistry products) provided good efficacy to maintain the stability of the PAA chemistry over a 17-22 months period.

Experiment #2: Ion Exchange Resin Addition to PAA Chemistry

Materials:

Bottle Wash:

Study #1: Lot 739865

Bottle wash is a product with similar concentration of hydrogen peroxide, acetic acid and peracetic acid to Medivators current products: Rapicide PA Part A, Renalin, Minncare, and REVOX PA without inclusion of Dequest.

Bottle wash was made to meet the criteria of the products described with without Dequest (stabilizer) added to the formulation. Due to the absence of Dequest, the product does not have the stability needed for used to replace the other PAA chemistry products. Bottle wash solution comprised 20-26 wt. % (35% concentration) hydrogen peroxide, 9-11 wt. % acetic acid, 5-5.5 wt. % peracetic acid with the remainder distilled water to equal 100 percent.

Amberlite Na⁺ 120 (ion exchange resin/polymer

0.5N Hydrochloric acid (used for the conditioning the ion exchange resin

50% Hydrogen peroxide

Glacial acetic acid

Analytical balance

All materials confirmed by PAA and hydrogen peroxide titration method described herein.

Procedure:

Condition the ion exchange resin:

300 mL of 0.5N hydrochloric acid was passed through the resin via a vacuum filter to condition the resin. After the hydrochloric acid was drained, 1000 mL of DI water was passed through the column to remove any remaining hydrochloric acid residual.

The resin was air dried before addition to the test solution.

Test Solution:

The bottle wash solution was diluted with DI water, glacial acetic acid and 50% hydrogen peroxide chemistry to match the initial concentration of Actril product with PAA concentration from 1000 ppm to 600 ppm PAA. The composition was approximately 1 wt. % to about 1.2 wt. % hydrogen peroxide, about 4.5 wt. % to about 5.5 wt. % acetic acid and about 0.06 wt. % to about 0.1 wt. % peracetic acid.

100 mL of the test solution was dispensed to a pre-rinsed bottle (HDPE) for testing.

For each study, one bottle of the test solution was keep as is with no additional components at room temperature and in the dark to represent the control sample.

For the test sample, a predetermined amount of Amberlite (after it was conditioned and air dried) was added to the test sample solution

All samples were analyzed for PAA and hydrogen peroxide concentration over time for stability analysis.

Results:

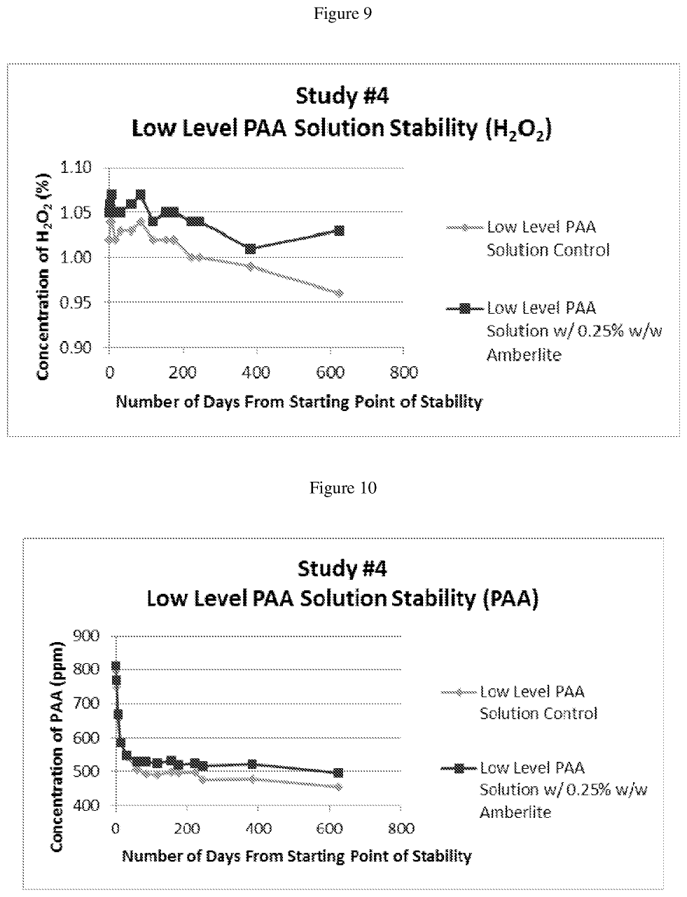

Study #4: (0.25% w/w Amberlite) FIG. 9 provides stability data of hydrogen peroxide for PAA chemistry without Dequest added. The data showed that with the addition of Amberlite directly to the bottle, the stability of hydrogen peroxide chemistry remained higher than that of the control sample without inclusion of Amberlite in the sample.

Study #4: (0.25% w/w Amberlite) FIG. 10 provides stability data of peracetic acid for PAA chemistry without the inclusion of Dequest. The data showed that with Amberlite addition to the chemistry, the PAA concentration stability was higher than the control sample (no stabilizer, Amberlite) after 21 months of stability.

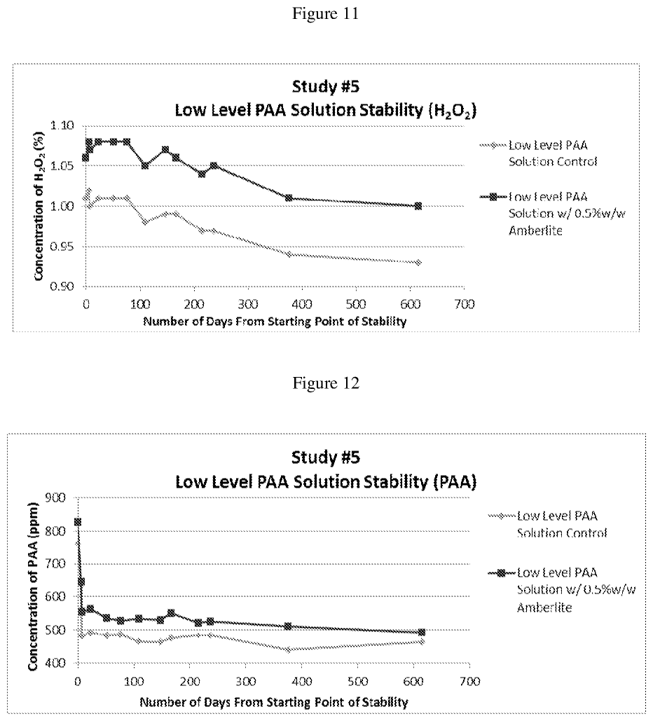

Study #5: (0.5% w/w Amberlite) FIG. 11 provides stability data of hydrogen peroxide for PAA chemistry without Dequest added. The data showed that with the addition of Amberlite directly to the bottle, the stability of hydrogen peroxide chemistry remained higher than that of the control sample without inclusion of Amberlite in the sample.

Study #5: (0.5% w/w Amberlite) FIG. 12 provides stability data of peracetic acid for PAA chemistry without the inclusion of Dequest. The data showed that with Amberlite addition to the chemistry, the PAA concentration stability was higher than the control sample (no stabilizer, Amberlite) after 21 months of stability.

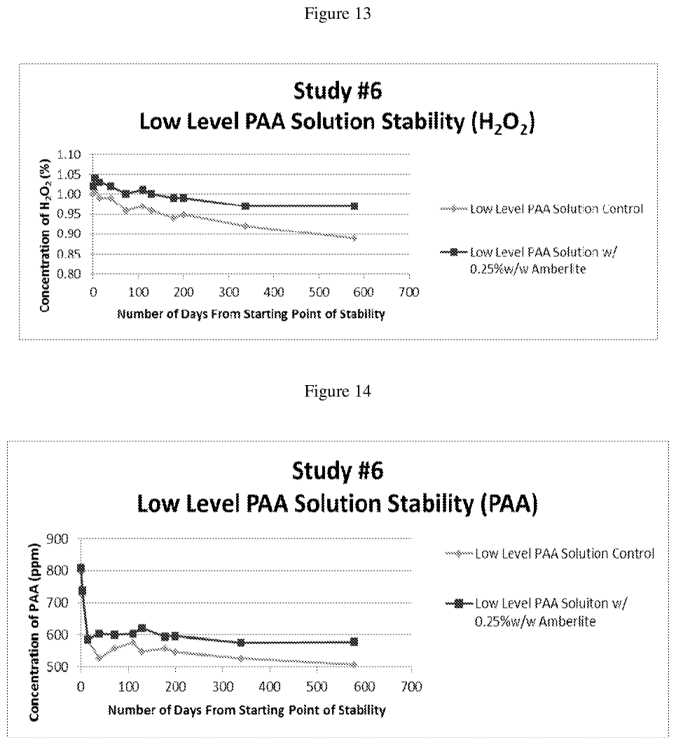

Study #6: (0.25% w/w Amberlite) FIG. 13 provides stability data of hydrogen peroxide for PAA chemistry without Dequest added. The data showed that with the addition of Amberlite directly to the bottle, the stability of hydrogen peroxide chemistry remained higher than that of the control sample without inclusion of Amberlite in the sample.

Study #6: (0.25% w/w Amberlite) FIG. 14 provides stability data of peracetic acid for PAA chemistry without the inclusion of Dequest. The data showed that with Amberlite addition to the chemistry, the PAA concentration stability was higher than the control sample (no stabilizer, Amberlite) after 21 months of stability. Studies #6 were a repeat of Studies #4, performed at the same time as Studies #4.

Conclusion: The results shown in FIGS. 9 to 14 with studies 4, 5 and 6 demonstrated that with Amberlite Na⁺ 120 resin directly added to the PAA chemistry system, the stability of both hydrogen peroxide and PAA were able to be maintained over a 20 to 21 month period.

Experiment #3: Stability with Ion Exchange Resin Addition in Presence of Iron Impurity

Materials:

Bottle Wash:

Bottle wash is a product with similar concentration of hydrogen peroxide, acetic acid and peracetic acid to Medivators current products: Rapicide PA Part A, Renalin, Minncare, and REVOX PA with the exclusion of Dequest.

Bottle wash was made to meet the criteria of the products described without Dequest (stabilizer) added to the formulation. Due to the absence of Dequest, the product does not have the stability needed for used to replace the other PAA chemistry products.

Amberlite Na⁺ 120 (ion exchange resin/polymer), Lot MKBF7889V

0.5N Hydrochloric acid (used for the conditioning the ion exchange resin)

Iron Sulfate (FeSO₄)

Dequest

Analytical balance

All materials confirmed by PAA and hydrogen peroxide titration method described herein.

Procedure:

Condition the ion exchange resin:

300 mL of 0.5N hydrochloric acid was passed through the resin via a vacuum filter to condition the resin.

After the hydrochloric acid was drained, 1000 mL of DI water was passed through the column to remove any remaining hydrochloric acid residual. The resin was air dried before addition to the test solution.

Sample Preparation Procedure:

A 5% FeSO₄ solution was prepared with DI water. This was used to catalyze the reaction of PAA with ionic iron which causes the PAA component of the solution chemistry to be unstable during storage. The addition of iron sulfate was used to simulate the condition where PAA chemistry was made with presence of impurity that can cause degradation of PAA and hydrogen peroxide.

Test Solution:

Solution #1: Bottle wash only. This was the control sample. The bottle wash solution contained about 22 wt. % to about 26 wt. % hydrogen peroxide, about 5 wt. % to about 6 wt. % peracetic acid and about 9 wt. % to about 11 wt. % acetic acid, with the remainder water to provide a 1 liter sample that was stored at room temperature.

Solution #2: Bottle wash with 1% Dequest. This was used as a control to simulate the current PAA chemistry product.

Solution #3: Bottle wash with 0.25% w/w Amberlite Na⁺ 120 (after conditioned and air dried).

For the purpose of the experiment, 5 different samples were made to analyze the stability of PAA and hydrogen peroxide:

Sample #1: 1000 mL of Solution #1 with 1 mL of 5% FeSO₄.

Sample #2: 1000 mL of Solution #2 with 1 mL of 5% FeSO₄.

Sample #3: 1000 mL of Solution #3 with 1 mL of 5% FeSO₄.

Sample #4: 1000 mL of Solution #3 with 0.5 mL of 5% FeSO₄.

Sample #5: 1000 mL of Solution #3 with 0.25 mL of 5% FeSO₄.

Samples 4 and 5 were prepared to test whether the Amberlite can be efficacious with lower concentrations of iron sulfate present. Since the testing was done with 0.25% w/w of Amberlite only in comparison to 1% w/w Dequest, sample #5 would be equivalent to Sample #1 in term of stabilizer to impurity concentrations.

All samples were analyzed for hydrogen peroxide and peracetic acid with titration method.

TABLE 4
Concentration of iron sulfate spiked in each test sample.

| Sample # | Concentration of FeSO₄ (ppm) |
|---|---|
| 1 | 50 |
| 2 | 50 |
| 3 | 50 |
| 4 | 25 |
| 5 | 12.5 |

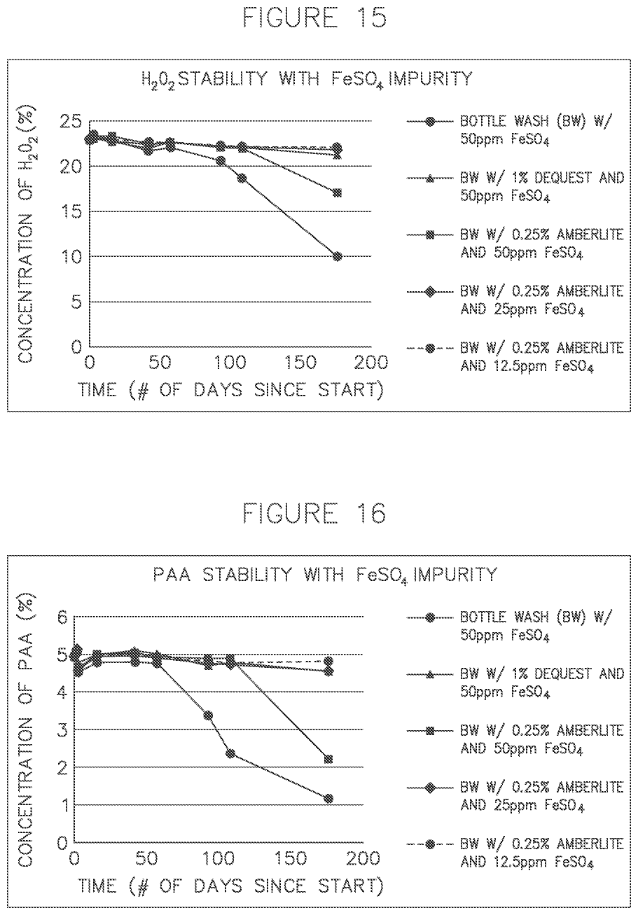

FIG. 15: Stability curves of hydrogen peroxide for Experiment #3 with and without stabilizers and different concentrations of iron sulfate as an impurity. The data showed that with Amberlite, the concentration of hydrogen peroxide was stable for up to 6 months in the presence of the iron sulfate impurity. The data also suggested that with a higher concentration of Amberlite, the stability of the chemistry can be matched with the 1% Dequest formulation. Based on the results, to match the same level of stability with 1% Dequest, the Amberlite concentration needed to be approximately 0.5% or higher.

FIG. 17: Stability curves of peracetic acid for Experiment #3 with and without stabilizers and different concentrations of iron sulfate as an impurity. The data showed that with Amberlite, the concentration of hydrogen peroxide was stable for up to 6 months in the presence of the iron sulfate impurity. The data also suggested that with a higher concentration of Amberlite, the stability of the chemistry can be matched with the 1% Dequest formulation. Based on the results, to match the same level of stability with 1% Dequest, the Amberlite concentration needed to be approximately 0.5% or higher.

Conclusions: The results in FIGS. 15 and 16 demonstrate that Amberlite has similar efficacy at keeping PAA chemistry stable in the presence of iron sulfate impurities as that of a Dequest stabilizer.

Real Time Stability Study

The capability of the ion-exchange resins and resin films to stabilize hydrogen peroxide and peracetic acid in REVOX PA were studied. These actives were monitored regularly throughout the study by iodometric titration and pH testing. The resins tested were Aquivion E98-15S Membrane Sheet, Aquivion E87-05S Membrane Sheet, Amberlite IRN99 Resin, Aquivion PW79S Resin, Amberlite IR120 Na+ Resin. Samples were stored at 25° C. (+/−2° C.) with 60% (+/−5%) relative humidity (RH) for 18-months to understand the shelf-life stability.

Three lots of sterilant were prepared and tested. Five different resins were tested with this study. One control containing no stabilizer was studied, as was one control of the unmodified current formulation of REVOX PA. These formulations and controls were divided into individual 4 oz. bottles (HDPE), each containing 100 mL of designated sample solution.

187 samples were prepared to satisfy 11 time points, along with 42 extras for replacements if needed, which made a total of 229 samples. The zero-time point was evaluated on the day of preparation and not stored with the other samples. The rest of the samples were stored at 25° C. (+/−2° C.) with 60% (+/−5) RH for up to 18-months. Each time a sample was pulled from storage pH was checked, visual observations made, and titrations were performed in triplicate.

Three lots were tested with each of the 5 resins. Based on previous work with the bromocresol purple titration of 10% acetic acid Renalin, the standard deviation (a) was 0.0362% acetic acid. The acceptable level of uncertainty (A) would be calculated by multiplying 10% acetic acid by 0.01 to obtain the value of 0.1% acetic acid. Therefore, the number of samples required to establish the amount of dilution is given by:

$$n = {( \frac{{Z}_{α \text{/} 2}}{d} )}^{2}$$

$$where$$

$$d = \frac{Δ}{σ}$$

for a 99% confidence interval, z_{α/2} is 2.58, so

$$n = {( \frac{2.58}{( 0.1 \% \text{/} 0.0362 \% )} )}^{2} = 0.872$$

The testing was performed in triplicates (n=3), which will exceed the sample requirements needed to establish the accelerated shelf-life with at least a 99% confidence level.

Materials and Apparatus

Aquivion E98-15S Membrane Sheet, Solvay; Catalog #: 802778-1EA; EW=980 g/mol SO₃H; Lot #: 17/15

Aquivion E87-05S, Membrane Sheet; Solvay; Catalog #: 802727-1EA; EW=870 g/mol SO₃H; Lot #: 18/15

Aquivion PW79S Resin; Aldrich; Catalog #: 802611-25G; EW=790 g/mol SO₃H; Lot #: N/A

Amberlite IRN99 Resin; Dow France; Code #: 10038876; Exchange Capacity: 2.5 eq/L; Lot #: N/A

Amberlite IR120 Na+ Resin; Aldrich; Catalog #: 224359-1 kg; Exchange Capacity: 2.0 meq/mL; Lot #: MKCC1943

Teflon Screen

Zip-Ties

Drain Filter

Ceramic Scissors

REVOX PA

REVOX PA with no Dequest (Bottle Wash Solution); Lot #'s: EWR6095-1, EWR6095-2, EWR6095-3.

DI Water

4 oz. Sample Bottles made of high density polyethylene (HDPE)

Sample Labels

Vented Caps

An Environmental Storage Chamber

Titration equipment

pH Meter, calibrated

Samples were divided into 4 oz. bottles (HDPE), each containing 100 mL of sample. The bottles were labeled with a time-point at which they were pulled from storage for analysis. Additional bottles for each formulation were labeled as ‘EXTRA’.

The membrane sheets were sliced to a desired size with the ceramic scissors. Then placed in the correctly labeled sample bottles with 100 mL of REVOX PA with no Dequest®, one slice per bottle. Using the equivalence weight specified on the membrane packages and the mass of the 2 cm×9 cm strip used, the amount of E98-15S was 0.00051 mol and E87-05S was 0.00023 mol in 100 ml of solution.

The resins were prepared by weighing out a desired mass of each resin. The resins were placed into PTFE filters and zip-tied shut with Teflon screen. One resin pouch was placed in each sample bottle with 100 mL of REVOX PA with no Dequest.

| Resin/Sheet | Resin Amount |
|---|---|
| Aquivion E98-15S | 2 × 9 cm Strip (~0.5 g) |
| Aquivion E87-05S | 2 × 9 cm Strip (~0.2 g) |
| Aquivion PW79S | 0.25% |
| Amberlite IRN99 | 0.25% |
| Amberlite IR120 Na+ | 0.25% |

The samples were stored on Day 0 in a 25° C. (+/−2° C.) with 60% (+/−5) RH environmental chamber until the pull point specified on the labels. All samples labeled Day 0 were not placed in storage, and were analyzed on this day.

Pull points for the samples were: Day 0, 1 Week, 2 Weeks, 3 Weeks, 4 weeks, 8 weeks, 13 weeks, 6 months, 9 months, 12 months, and 18 months.

Samples were pulled on the time point marked, within a pull window equal, in days, to the number of weeks from Day 0 in the pull-point designation. For example, the 8-week pull will occurred between 8 weeks and 8 weeks plus 8 days after Day 0. T-1 was 1 week; T-2 was 2 weeks; T-3 was 3 weeks; T-4 was 4 weeks; T-5 was 8 weeks and T-6 was 13 weeks.

Each solution was analyzed within five days of its pull point.

The titration method described herein was used to determine hydrogen peroxide, peracetic acid, and acetic acid in each of the REVOX PA samples. Titrations were performed in triplicate.

The pH levels were checked for each sample using a calibrated pH meter.

Visual observations were made to monitor the color and clarity of the solution and any physical changes of the resins. If resins were observed to have degraded or dissolved, the samples in question were subjected to further laboratory analysis.

The following table lists the acceptance criteria. The peracetic acid specification used was 4.8-6.0% to confine to the end of shelf-life requirement of the sterilization process. These specifications were used as acceptance criteria for this study. The titrations were performed in triplicate and required a standard deviation of 5% or less to be acceptable for this study.

| Components | Specification |
|---|---|
| Hydrogen Peroxide | 21.0 to 24.0% |
| Peracetic Acid | 4.8 to 6.0% |
| Acetic Acid | 9.0 ± 1.0% |
| pH | 0.8 ± 0.3 |

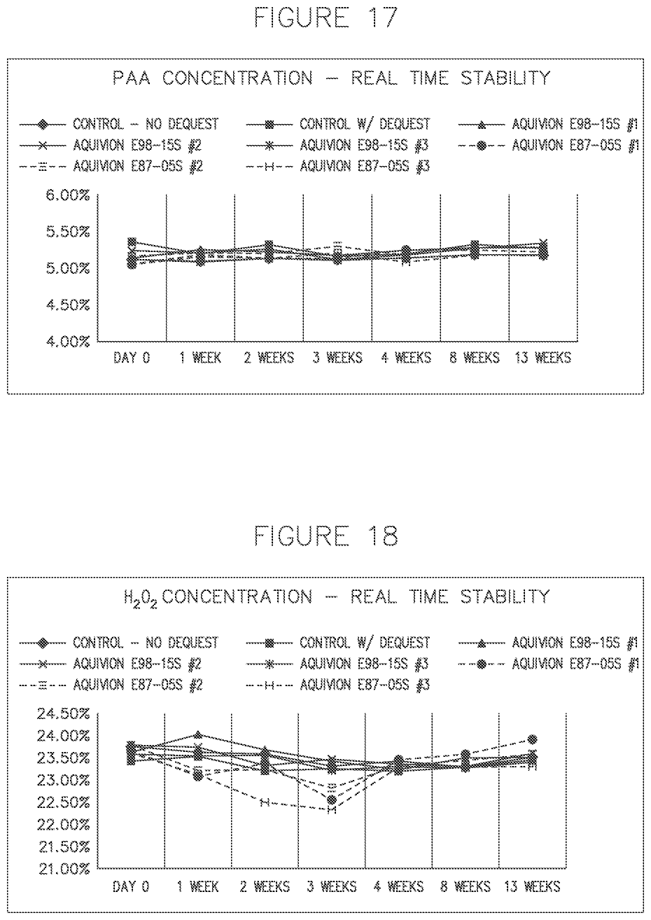

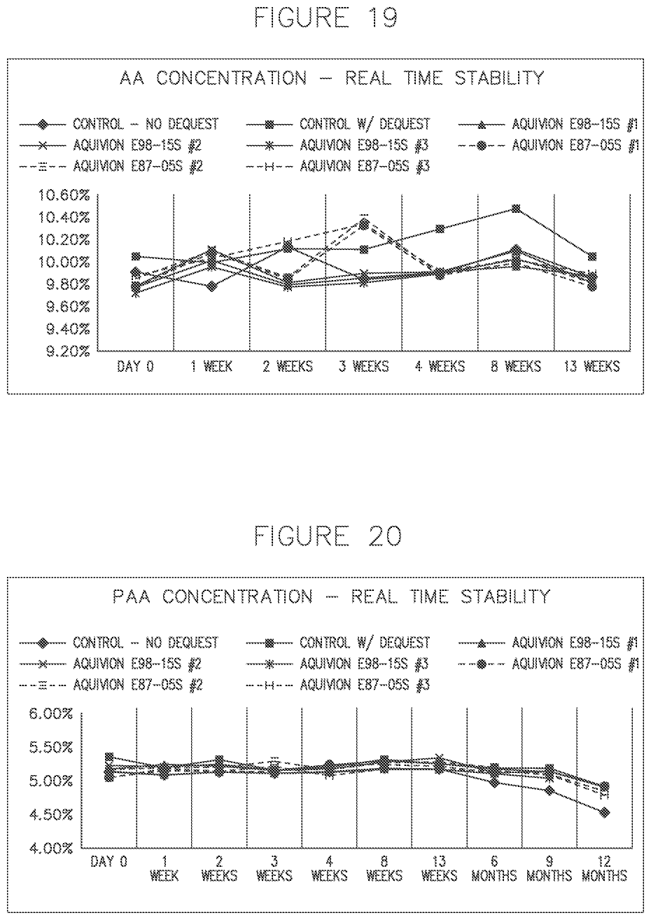

The results are shown in Tables 4 through 6 and FIGS. 17 through 19.

TABLE 4
Stability results of the control samples; with and without Dequest.

| | | | | | AVG | AVG | AVG |
|---|---|---|---|---|---|---|---|
| SAMPLES | LOT | TIMEPOINT | PH | APPEARANCE | H2O2 % | PAA % | AA % |
| REVOX PA SPEC: | | | 0.5-1.1 | CLEAR | 21.0-24.0% | 4.8-6.0% | 8.0-10.0% |
| CONTROL- | 1 | T-0 | 1.3 | CLEAR | 23.7% | 5.1% | 9.9% |
| NO | | T-1 | 1.5 | CLEAR | 23.6% | 5.1% | 9.8% |
| DEQUEST | | T-2 | 1.4 | CLEAR | 23.6% | 5.3% | 10.1% |
| | | T-3 | 1.4 | CLEAR | 23.3% | 5.1% | 9.8% |
| | | T-4 | 1.5 | CLEAR | 23.4% | 5.1% | 9.9% |
| | | T-5 | 1.5 | CLEAR | 23.3% | 5.2% | 10.1% |
| | | T-6 | 1.4 | CLEAR | 23.5% | 5.2% | 9.9% |
| CONTROL | 1 | T-0 | 0.7 | CLEAR | 23.5% | 5.4% | 10.0% |
| W/ | | T-1 | 0.9 | CLEAR | 23.5% | 5.2% | 10.0% |
| DEQUEST | | T-2 | 0.9 | CLEAR | 23.2% | 5.3% | 10.1% |
| | | T-3 | 0.9 | CLEAR | 23.3% | 5.2% | 10.1% |
| | | T-4 | 0.8 | CLEAR | 23.2% | 5.2% | 10.3% |
| | | T-5 | 0.9 | CLEAR | 23.3% | 5.3% | 10.5% |
| | | T-6 | 0.7 | CLEAR | 23.4% | 5.2% | 10.1% |

TABLE 5
Stability results of the Aquivion E98-15S samples.

| | | | | | AVG | AVG | AVG |
|---|---|---|---|---|---|---|---|
| SAMPLES | LOT | TIMEPOINT | PH | APPEARANCE | H2O2 % | PAA % | AA % |
| REVOX PA SPEC: | | | 0.5-1.1 | CLEAR | 21.0-24.0% | 4.8-6.0% | 8.0-10.0% |
| AQUIVION | 1 | T-0 | 1.3 | CLEAR W/CLEAR RESIN SHEET | 23.7% | 5.2% | 9.8% |
| E98-15S | | T-1 | 1.4 | CLEAR W/CLEAR RESIN SHEET | 24.0% | 5.2% | 10.0% |
| | | T-2 | 1.3 | CLEAR W/CLEAR RESIN SHEET | 23.7% | 5.2% | 9.8% |
| | | T-3 | 1.1 | CLEAR W/CLEAR RESIN SHEET | 23.4% | 5.2% | 9.9% |
| | | T-4 | 1.4 | CLEAR W/CLEAR RESIN SHEET | 23.3% | 5.2% | 9.9% |
| | | T-5 | 1.3 | CLEAR W/CLEAR RESIN SHEET | 23.5% | 5.3% | 10.0% |
| | | T-6 | 1.2 | CLEAR WITH SHEET | 23.5% | 5.3% | 9.9% |
| | 2 | T-0 | 1.2 | CLEAR W/CLEAR RESIN SHEET | 23.7% | 5.2% | 9.8% |
| | | T-1 | 1.5 | CLEAR W/CLEAR RESIN SHEET | 23.7% | 5.2% | 10.1% |
| | | T-2 | 1.4 | CLEAR W/CLEAR RESIN SHEET | 23.3% | 5.3% | 9.8% |
| | | T-3 | 1.2 | CLEAR W/CLEAR RESIN SHEET | 23.5% | 5.1% | 9.9% |
| | | T-4 | 1.4 | CLEAR W/CLEAR RESIN SHEET | 23.3% | 5.2% | 9.9% |
| | | T-5 | 1.4 | CLEAR W/CLEAR RESIN SHEET | 23.3% | 5.3% | 10.1% |
| | | T-6 | 1.2 | CLEAR WITH SHEET | 23.6% | 5.3% | 9.8% |
| | 3 | T-0 | 1.4 | CLEAR W/CLEAR RESIN SHEET | 23.6% | 5.1% | 9.7% |
| | | T-1 | 1.3 | CLEAR W/CLEAR RESIN SHEET | 23.5% | 5.1% | 10.0% |
| | | T-2 | 1.4 | CLEAR W/CLEAR RESIN SHEET | 23.6% | 5.1% | 9.8% |
| | | T-3 | 1.2 | CLEAR W/CLEAR RESIN SHEET | 23.2% | 5.1% | 9.8% |
| | | T-4 | 1.3 | CLEAR W/CLEAR RESIN SHEET | 23.3% | 5.1% | 9.9% |
| | | T-5 | 1.4 | CLEAR W/CLEAR RESIN SHEET | 23.3% | 5.3% | 10.0% |
| | | T-6 | 1.4 | CLEAR WITH SHEET | 23.4% | 5.2% | 9.9% |

TABLE 6
Stability results of the Aquivion E87-05S samples.

| | | | | | AVG | AVG | AVG |
|---|---|---|---|---|---|---|---|
| SAMPLES | LOT | TIMEPOINT | PH | APPEARANCE | H2O2 % | PAA % | AA % |
| REVOX PA SPEC: | | | 0.5-1.1 | CLEAR | 21.0-24.0% | 4.8-6.0% | 8.0-10.0% |
| AQUIVION | 1 | T-0 | 1.4 | CLEAR W/CLEAR RESIN SHEET | 23.8% | 5.1% | 9.7% |
| E87-05S | | T-1 | 1.5 | CLEAR W/CLEAR RESIN SHEET | 23.7% | 5.2% | 10.0% |
| | | T-2 | 1.4 | CLEAR W/CLEAR RESIN SHEET | 23.6% | 5.2% | 9.8% |
| | | T-3 | 1.2 | CLEAR W/CLEAR RESIN SHEET | 23.5% | 5.1% | 9.8% |
| | | T-4 | 1.1 | CLEAR W/CLEAR RESIN SHEET | 23.5% | 5.3% | 9.9% |
| | | T-5 | 1.3 | CLEAR W/CLEAR RESIN SHEET | 23.6% | 5.4% | 10.0% |
| | | T-6 | 1.3 | CLEAR WITH SHEET | 23.9% | 5.2% | 9.8% |
| | 2 | T-0 | 1.4 | CLEAR W/CLEAR RESIN SHEET | 24.1% | 5.2% | 9.7% |
| | | T-1 | 1.3 | CLEAR W/CLEAR RESIN SHEET | 23.5% | 5.2% | 10.0% |
| | | T-2 | 1.5 | CLEAR W/CLEAR RESIN SHEET | 23.6% | 5.2% | 9.7% |
| | | T-3 | 1.4 | CLEAR W/CLEAR RESIN SHEET | 23.4% | 5.3% | 9.8% |
| | | T-4 | 1.3 | CLEAR W/CLEAR RESIN SHEET | 23.3% | 5.2% | 9.9% |
| | | T-5 | 1.3 | CLEAR W/CLEAR RESIN SHEET | 23.4% | 5.3% | 10.0% |
| | | T-6 | 1.3 | CLEAR WITH SHEET | 23.6% | 5.3% | 9.8% |
| | 3 | T-0 | 1.3 | CLEAR W/CLEAR RESIN SHEET | 23.6% | 5.1% | 9.8% |
| | | T-1 | 1.6 | CLEAR W/CLEAR RESIN SHEET | 23.6% | 5.2% | 10.0% |
| | | T-2 | 1.4 | CLEAR W/CLEAR RESIN SHEET | 23.4% | 5.1% | 9.7% |
| | | T-3 | 1.3 | CLEAR W/CLEAR RESIN SHEET | 23.4% | 5.2% | 9.8% |
| | | T-4 | 1.3 | CLEAR W/CLEAR RESIN SHEET | 23.3% | 5.1% | 9.9% |
| | | T-5 | 1.3 | CLEAR W/CLEAR RESIN SHEET | 23.3% | 5.2% | 10.0% |
| | | T-6 | 1.3 | CLEAR WITH SHEET | 23.3% | 5.2% | 9.9% |

The concentration of peracetic acid in the samples remained similar to the Dequest sample, with very little fluctuations throughout the study. All samples met specifications for peracetic acid.

The hydrogen peroxide concentrations remained in specification (21-24%) throughout the study. The T-0 titration for one of the Aquivion E87-05S lots was slightly higher than the specification, but all other samples met the requirements.

Due to the low pH of Dequest 2010, the removal of the stabilizer caused the pH level to rise higher than the maximum specification of pH 1.1. All samples without Dequest maintained a pH between 1.1 to 1.6.

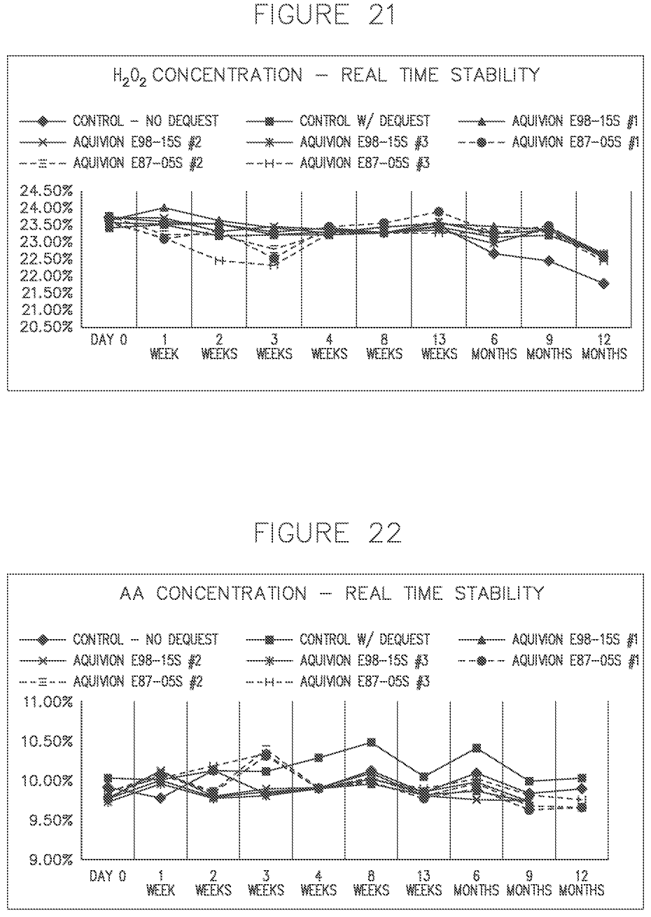

Longer term stability test results are shown in Tables 7 through 9 and FIGS. 20 through 22. Samples #2 and #3 are duplicates of Sample #1 in each test.

TABLE 7
PAA Degradation during Real Time Study

| Samples | Day 0 | 1 week | 2 weeks | 3 weeks | 4 weeks | 8 weeks | 13 weeks | 6 month | 9-month | 12-month | 18-month |
|---|---|---|---|---|---|---|---|---|---|---|---|
| Control- No Dequest | 5.05% | 5.14% | 5.29% | 5.12% | 5.11% | 5.20% | 5.18% | 4.98% | 4.86% | 4.53% | |
| Control w/Dequest | 5.36% | 5.19% | 5.32% | 5.15% | 5.21% | 5.32% | 5.24% | 5.18% | 5.19% | 4.91% | |
| Aquivion E98-15S #1 | 5.17% | 5.24% | 5.23% | 5.20% | 5.23% | 5.29% | 5.27% | 5.16% | 5.11% | | |
| Aquivion E98-15S #2 | 5.23% | 5.20% | 5.26% | 5.14% | 5.17% | 5.27% | 5.35% | 5.09% | 5.14% | | |
| Aquivion E98-15S #3 | 5.13% | 5.09% | 5.13% | 5.11% | 5.14% | 5.18% | 5.19% | 5.12% | 5.04% | | |
| Aquivion E87-05S #1 | 5.06% | 5.17% | 5.16% | 5.14% | 5.25% | 5.27% | 5.22% | 5.15% | 5.14% | 4.91% | |
| Aquivion E87-05S #2 | 5.16% | 5.20% | 5.20% | 5.30% | 5.17% | 5.28% | 5.29% | 5.22% | 5.09% | 4.84% | |
| Aquivion E87-05S #3 | 5.06% | 5.18% | 5.14% | 5.22% | 5.08% | 5.18% | 5.18% | 5.16% | 5.10% | 4.79% | |
| Amberlite IR120Na+ | 5.02% | 4.63% | 5.09% | 4.44% | | | | | | | |
| | 5.06% | 4.64% | 5.23% | 4.72% | | | | | | | |
| | 4.96% | 4.71% | 4.52% | 4.46% | | | | | | | |
| Amberlite IRN99 | 4.80% | 4.77% | 4.90% | 4.78% | | | | | | | |
| | 5.01% | 4.79% | 4.82% | 4.83% | | | | | | | |
| | 4.94% | 4.70% | 4.88% | 4.73% | | | | | | | |
| Aquivon PW79S | 5.07% | 4.99% | 4.99% | 4.96% | | | | | | | |
| | 4.84% | 4.96% | 5.01% | 5.00% | | | | | | | |
| | 4.86% | 4.88% | 4.91% | 4.90% | | | | | | | |

| | |
|---|---|
| Revox PA Spec: | 4.8-6.0% |
| End of Shelf-life: | 4.43% |

TABLE 8
AA Degradation during Real Time Study

| | | | | | | | | | | |
|---|---|---|---|---|---|---|---|---|---|---|
| Day 0 | 1 week | 2 weeks | 3 weeks | 4 weeks | 8 weeks | 13 weeks | 6 month | 9 month | 12-month | 18-month |

| | | | | | | | | | | |
|---|---|---|---|---|---|---|---|---|---|---|
| Control- No Dequest | 9.92% | 9.78% | 10.13% | 9.84% | 9.90% | 10.11% | 9.85% | 10.09% | 9.83% | 9.90% |
| Control w/Dequest | 10.05% | 9.99% | 10.12% | 10.11% | 10.29% | 10.48% | 10.05% | 10.41% | 9.99% | 10.03% |
| Aquivion E98-15S #1 | 9.77% | 10.01% | 9.79% | 9.86% | 9.89% | 9.96% | 9.88% | 9.86% | 9.75% | |
| Aquivion E98-15S #2 | 9.78% | 10.11% | 9.80% | 9.90% | 9.91% | 10.09% | 9.81% | 9.76% | 9.73% | |
| Aquivion E98-15S #3 | 9.72% | 9.95% | 9.77% | 9.81% | 9.90% | 10.01% | 9.85% | 9.98% | 9.72% | |
| Aquivion E87-05S #1 | 9.79% | 10.06% | 9.86% | 10.33% | 9.90% | 10.00% | 9.78% | 9.90% | 9.63% | 9.67% |
| Aquivion E87-05S #2 | 9.85% | 10.09% | 9.86% | 10.39% | 9.88% | 10.04% | 9.81% | 9.97% | 9.68% | 9.65% |
| Aquivion E87-05S #3 | 9.88% | 10.03% | 10.18% | 10.34% | 9.91% | 10.01% | 9.90% | 10.03% | 9.81% | 9.75% |
| Amberlite IR120Na+ | 9.92% | 10.27% | 10.11% | 10.16% | | | | | | |
| | 9.92% | 10.11% | 10.03% | 10.17% | | | | | | |
| | 10.00% | 10.26% | 10.15% | 10.12% | | | | | | |
| Amberlite IRN99 | 9.72% | 9.99% | 9.76% | 9.79% | | | | | | |
| | 9.72% | 9.95% | 9.74% | 9.81% | | | | | | |
| | 9.84% | 9.98% | 9.72% | 9.79% | | | | | | |
| Aquivon PW79S | 9.86% | 10.20% | 9.95% | 10.09% | | | | | | |
| | 9.80% | 10.11% | 10.02% | 10.09% | | | | | | |
| | 9.81% | 10.10% | 9.89% | 10.05% | | | | | | |
| | Revox | H2O2 | 8.0-10.0% | | | | | | | |
| | Spec: | | | | | | | | | |

End of Shelf-life:

TABLE 9
H2O2 Degradation during Real Time Study

| | Day 0 | 1 week | 2 weeks | 3 weeks | 4 weeks | 8 weeks | 13 weeks | 6 month | 9 month | 12-month | 18-month |
|---|---|---|---|---|---|---|---|---|---|---|---|
| Control- No Dequest | 23.75% | 23.62% | 23.56% | 23.31% | 23.42% | 23.27% | 23.50% | 22.67% | 22.48% | 21.80% | |
| Control w/Dequest | 23.46% | 23.54% | 23.21% | 23.27% | 23.23% | 23.33% | 23.44% | 23.18% | 23.23% | 22.66% | |
| Aquivion E98-15S #1 | 23.66% | 24.04% | 23.67% | 23.43% | 23.26% | 23.49% | 23.55% | 23.48% | 23.36% | | |
| Aquivion E98-15S #2 | 23.75% | 23.74% | 23.33% | 23.48% | 23.35% | 23.29% | 23.59% | 23.27% | 23.38% | | |
| Aquivion E98-15S #3 | 23.59% | 23.54% | 23.55% | 23.23% | 23.31% | 23.26% | 23.39% | 22.99% | 23.42% | | |
| Aquivion E87-05S #1 | 23.66% | 23.14% | 23.37% | 22.55% | 23.47% | 23.60% | 23.91% | 23.31% | 23.50% | 22.57% | |
| Aquivion E87-05S #2 | 23.78% | 23.23% | 23.24% | 22.80% | 23.33% | 23.43% | 23.58% | 23.31% | 23.33% | 22.63% | |
| Aquivion E87-05S #3 | 23.60% | 23.13% | 22.49% | 22.34% | 23.29% | 23.29% | 23.32% | 23.28% | 23.33% | 22.47% | |
| Amberlite IR120Na+ | 23.59% | 23.08% | 23.34% | 22.75% | | | | | | | |
| | 23.57% | 23.16% | 23.17% | 22.86% | | | | | | | |
| | 23.38% | 22.72% | 22.90% | 22.80% | | | | | | | |
| Amberlite IRN99 | 23.83% | 23.67% | 23.62% | 23.48% | | | | | | | |
| | 24.13% | 23.47% | 23.56% | 23.44% | | | | | | | |
| | 23.61% | 23.55% | 23.40% | 23.44% | | | | | | | |
| Aquivon PW79S | 23.71% | 23.40% | 23.18% | 23.14% | | | | | | | |
| | 23.56% | 23.28% | 23.30% | 23.19% | | | | | | | |
| | 23.30% | 23.31% | 23.18% | 22.98% | | | | | | | |

| | |
|---|---|
| Revox H2O2 Spec: | 21-24% |
| End of Shelf-life: | |

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

1. A method to stabilize a peracetic acid and hydrogen peroxide solution comprising the step:
contacting a peracetic acid and hydrogen peroxide solution with a polymeric resin functionalized with sulfonic acid to provide a treated peracetic acid and hydrogen peroxide solution wherein the peracetic acid and hydrogen peroxide solution is contacted with an interior portion of a container wall that includes the polymeric resin functionalized with the sulfonic acid, wherein the interior portion of the container wall incorporates the polymeric resin functionalized with sulfonic acid via a coating, or is extruded into the material comprising container wall or is embedded into the container wall.

2-4. (canceled)

5. The method according to claim 1, wherein the container comprises a material that is a polypropylene, a polyethylene, a polypropylene and polyethylene copolymer or a polyethylene and polypropylene blend.

6. The method according to claim 1, wherein the polymeric resin functionalized with the sulfonic acid is a divinyl benzene/styrene copolymer, a perfluorosulfonic acid resin or a polymer containing a 2-acrylamido-2-methylpropane sulfonic acid resin.

7. The method according to claim 1, wherein the polymeric resin functionalized with the sulfonic acid is crosslinked.

8. The method according to claim 1, wherein the treated peracetic acid and hydrogen peroxide solution is stable at ambient conditions for at least 180 days, 365 days or 545 days.

9. The method according to claim 8, wherein the treated peracetic acid and hydrogen peroxide solution retains at least a 60% concentration of the original concentration of the peracetic acid after at least 180 days, 365 days or 545 days.

10. The method according to claim 9, wherein the treated peracetic acid and hydrogen peroxide solution retains at least 80% concentration of the original concentration of the peracetic acid after at least 180 days, 365 days or 545 days.

11. The method according to claim 8, wherein the treated peracetic acid and hydrogen peroxide solution retains at least 80% concentration of the original concentration of hydrogen peroxide after at least 180 days, 365 days or 545 days.

12. The method according to claim 11, wherein the treated peracetic acid and hydrogen peroxide solution retains at least 90% concentration of the original concentration of hydrogen peroxide after at least 180 days, 365 days or 545 days.

13. A container comprising:
a container wall having an interior surface and an exterior surface, the container wall defining an interstitial space, wherein the container is sealable, wherein the container material that forms the container wall comprises a polymeric resin functionalized with sulfonic acid associated with the interior surface of the container, wherein the container material is a polypropylene, a polyethylene, a polypropylene and polyethylene copolymer or a polyethylene and polypropylene blend.

14. The container according to claim 13, wherein the polymeric resin functionalized with the sulfonic acid is coated onto the interior surface of the container.

15. The container according to claim 13, wherein the polymeric resin functionalized with the sulfonic acid is embedded into the interior surface of the container.

16. The container according to claim 13, wherein the polymer resin functionalized with the sulfonic acid is extruded into the material that forms the container wall.

17. (canceled)

18. The container according to claim 13, wherein the polymeric resin functionalized with the sulfonic acid is a divinyl benzene/styrene copolymer, a perfluorosulfonic acid resin or a polymer containing a 2-acrylamido-2-methylpropane sulfonic acid resin.

19. The container according to claim 13, wherein the polymeric resin functionalized with the sulfonic acid is crosslinked.

20. The container of according to claim 13, further comprising an outer coating or layer applied to the exterior portion of the container.

21-106. (canceled)
